(19) United States
(12) Patent Application Publication
(10) Pub. No.: US 2026/0291907 A1
(43) Pub. Date: Sep. 24, 2026

(54) SYSTEM

(71) Applicant: SoftBank Group Corp., Tokyo (JP)

(72) Inventor: Satoshi HIKINO, Minato-ku, Tokyo (JP)

(73) Assignee: SoftBank Group Corp., Tokyo (JP)

(21) Appl. No.: 19/568,846

(22) Filed: Mar. 17, 2026

(30) Foreign Application Priority Data
Mar. 19, 2025 (JP) 2025-045177

(51) Int. Cl. H04L 51/224; G06F 40/30; G06V 40/16; G10L 25/63; H04L 9/40

(52) U.S. Cl. CPC H04L 51/224; G06F 40/30; H04L 63/1425; G06V 40/174; G10L 25/63

(57) ABSTRACT

A system includes a processor that is configured to generate a prompt that instructs a generative artificial intelligence model to evaluate a risk level of an email in order to determine, based on content of a body of the email, whether the email is a dangerous email or a non-dangerous email, compare identification information included in the email with a database in order to determine an origin or source of the identification information and evaluate a reliability of the email based on a result of the comparison, and analyze at least one of a facial expression and a voice of a user by using emotion recognition technology in order to recognize an emotion of the user and adjust a danger level of the email based on the recognized emotion.

### CROSS-REFERENCE TO RELATED APPLICATION

This application is based on and claims priority under 35 USC 119 from Japanese Patent Application No. 2025-045177 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional email security systems generally evaluate the risk of emails based on static rule sets, keyword filters, blacklist or whitelist databases, and sometimes conventional machine learning models. These approaches primarily focus on the email content, sender information, and embedded links or attachments, and do not flexibly utilize the powerful contextual understanding and generative capabilities of recent generative artificial intelligence models. As a result, such systems may fail to accurately determine whether an email is dangerous or non-dangerous in cases where attackers use sophisticated wording, obfuscation techniques, or novel attack patterns that are not explicitly captured by existing rules or signatures. In addition, conventional systems typically treat identification information, such as URLs, phone numbers, or account identifiers, in a simple binary manner based on limited reputation data, and do not perform integrated reliability evaluation that considers both the database comparison result and a contextual understanding of the email as a whole. Furthermore, conventional email security solutions generally treat all users in a uniform way and do not take into account the emotional state of an individual user at the time of receiving or viewing an email. However, a user's emotional state, such as heightened anxiety, stress, or urgency, may significantly increase the practical risk that the user will respond to a phishing or fraudulent email, even if the technical risk score of the email content itself is moderate. Existing systems typically do not recognize user emotions based on facial expressions or voice and do not adjust the danger level or notification priority accordingly. Therefore, there is a need for an email security system that (i) leverages generative artificial intelligence models through appropriate prompts to evaluate email risk more flexibly and contextually, (ii) evaluates reliability by comparing identification information with a database and combining that comparison with overall risk assessment, and (iii) recognizes and incorporates a user's emotional state into the danger evaluation and notification logic, thereby improving the practical safety and usability of email communication.

### SUMMARY

In order to solve the above-described problems, a system according to one aspect of the present invention comprises a processor, wherein the processor is configured to generate a prompt that instructs a generative artificial intelligence model to evaluate a risk level of an email in order to determine, based on content of a body of the email, whether the email is a dangerous email or a non-dangerous email. By generating such a prompt, the processor causes the generative artificial intelligence model to perform contextual interpretation of the email body, including the meaning and intent of sentences, the presence of deceptive or coercive expressions, and combinations of words and phrases, thereby enabling a flexible and adaptive danger evaluation that is not limited to static rule sets or simple keyword matching. The processor is further configured to compare identification information included in the email, such as URLs, phone numbers, account identifiers, or other contact information, with a database in order to determine an origin or source of the identification information and evaluate a reliability of the email based on a result of the comparison. Through this comparison, the processor can identify whether the identification information corresponds to a known legitimate entity, a known malicious entity, or an unknown entity, and can reflect this result in the overall reliability and danger assessment of the email. Moreover, the processor is configured to analyze at least one of a facial expression and a voice of a user by using emotion recognition technology in order to recognize an emotion of the user and adjust a danger level of the email based on the recognized emotion. For example, when the user is recognized as being in an anxious, stressed, or highly excited emotional state, the processor can raise the effective danger level, tighten thresholds for warnings, and increase the likelihood of presenting strong alerts or additional confirmation steps. In a preferred embodiment, the processor is configured to analyze the body of the email by using natural language processing and extract specific keywords or phrases from the body of the email so as to provide additional structured features to the generative artificial intelligence model or to auxiliary risk-scoring logic. In another preferred embodiment, the processor is configured to set a priority of the email based on a result of emotion analysis of the user and generate a prompt for notifying the user according to the set priority, thereby controlling the timing, strength, and manner of notifications in accordance with both the technical danger level and the user's emotional state. Through these combined means, the system can perform integrated, context-aware, and user-aware email danger evaluation and notification, and can thereby improve protection against phishing and other fraudulent emails while maintaining usability.

The term “processor” refers to any hardware logic device or combination of hardware and software, including but not limited to a central processing unit (CPU), a microprocessor, a microcontroller, a digital signal processor (DSP), a graphics processing unit (GPU), or a dedicated logic circuit, that is capable of executing instructions to perform the operations described in the claims.

The term “email” refers to an electronic message transmitted over a communication network, the message including at least a sender address, a recipient address, and a body, and optionally including a subject, headers, attachments, embedded links, and identification information.

The term “email body” refers to a portion of an email that contains the main textual content intended to be read by a user, excluding meta-information such as headers and protocol data.

The term “dangerous email” refers to an email that is determined, by the system, to have a risk of causing harm to a user or a system, such as phishing emails, fraud emails, malware distribution emails, or other emails with malicious or deceptive intent.

The term “non-dangerous email” refers to an email that is determined, by the system, not to present a significant risk of harm to a user or a system and that does not fall within the category of dangerous email.

The term “generative artificial intelligence model” refers to a machine learning model, such as a large language model, a generative adversarial network, or a similar architecture, that is capable of generating or evaluating text or other content based on input data and learned parameters.

The term “prompt” refers to data, typically including natural language text and optionally including structured parameters or examples, that is supplied to a generative artificial intelligence model to instruct the model to perform a specified task, such as evaluating a risk level of an email.

The term “risk level” refers to a quantitative or qualitative indication of the likelihood or severity of potential harm associated with an email, including, for example, a probability score, a numerical value, or a categorical level such as “low,” “medium,” or “high.”

The term “identification information” refers to information included in an email that can be used to identify or contact an entity, such as a URL, a domain name, an email address, a phone number, an account identifier, or similar data.

The term “database” refers to any structured collection of data, stored in one or more storage devices, that is accessible by the processor and that contains, for example, reputation information or reference information regarding identification information, senders, domains, or organizations.

The term “reliability” refers to a degree of trustworthiness or authenticity associated with an email or identification information, determined based on comparison with database entries, contextual analysis, or other evaluation criteria.

The term “user” refers to a human operator or recipient who uses a terminal or client device to receive, view, or interact with emails analyzed by the system.

The term “emotion” refers to a psychological state of the user, such as calmness, anxiety, stress, fear, excitement, or urgency, inferred from observable signals including facial expressions, voice features, or other biometric or behavioral data.

The term “emotion recognition technology” refers to hardware, software, or a combination thereof that processes signals such as images of a user's face, audio recordings of a user's voice, or other sensor data, in order to determine or estimate the user's emotional state.

The term “facial expression” refers to visual features of a user's face, including movements and configurations of facial muscles, as captured by a camera or image sensor, and used as input for emotion recognition technology.

The term “voice” refers to an audio signal produced by a user when speaking and captured by a microphone or other audio sensor, the signal being analyzed to extract features such as tone, pitch, volume, prosody, and other characteristics relevant to emotion recognition.

The term “danger level” refers to a value or category representing the evaluated degree of danger associated with an email, which may be adjusted based on both technical analysis of the email and the recognized emotion of the user.

The term “natural language processing” refers to computational techniques and algorithms for analyzing, understanding, and manipulating human language text, including operations such as tokenization, parsing, part-of-speech tagging, semantic analysis, keyword extraction, and intent detection.

The term “keyword” refers to a word or term contained in an email body that is identified as having particular significance for risk evaluation, such as “password,” “urgent,” “payment,” or other terms indicative of phishing or fraud.

The term “phrase” refers to a sequence of two or more words occurring in an email body that is treated as a single unit for analysis, including expressions such as “enter your password” or “send money now,” and that may indicate a potential risk pattern.

The term “emotion analysis result” refers to data representing the outcome of processing by the emotion recognition technology, including a determined or estimated emotional state, one or more emotion scores, or other parameters derived from the user's facial expression or voice.

The term “priority of the email” refers to an order or importance level assigned to an email, which determines how or when the email is presented, highlighted, or notified to the user, relative to other emails.

The term “prompt for notifying the user” refers to information generated by the processor that causes a terminal or client application to present a notification to the user, such as a visual, auditory, or haptic alert, wherein the content or intensity of the notification is based on the priority of the email.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

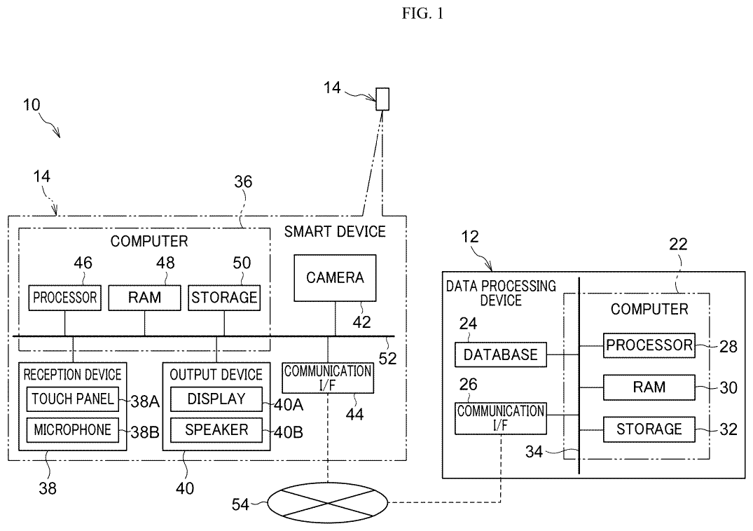

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

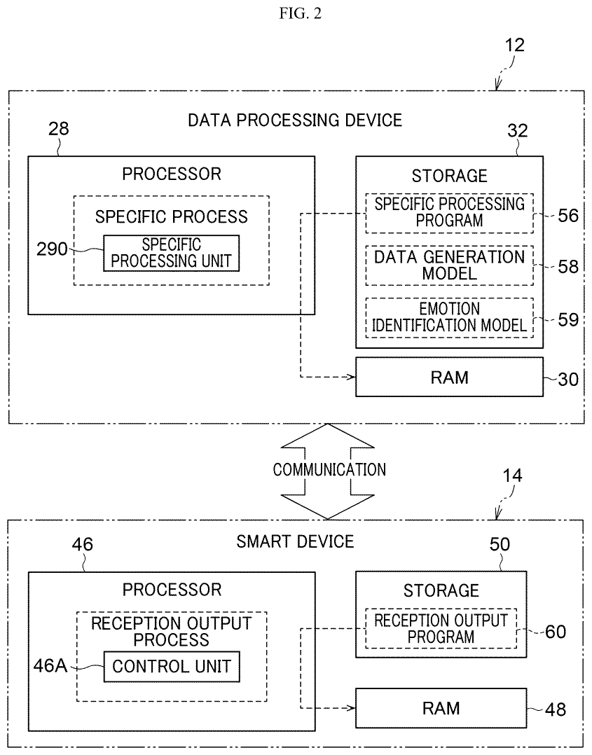

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional electronic communication filtering technologies, such as rule-based spam filters and static machine learning classifiers, primarily rely on fixed keyword lists, manually engineered features, or pre-trained discriminative models applied directly to message text. These approaches suffer from multiple technical limitations in the context of modern, dynamically evolving phishing and fraud communications.

First, conventional systems generally perform danger evaluation by applying a classifier directly to raw or lightly preprocessed text. Such systems do not flexibly adapt the evaluation task specification or output format at inference time, and therefore cannot reliably obtain rich, structured explanations or fine-grained risk information from advanced models. As a result, the internal processing pipeline of the server is constrained to coarse labels, which limits the ability to generate detailed, machine-understandable danger assessments suitable for downstream automated handling, logging, or user interface control.

Second, although large generative artificial intelligence models can, in principle, provide nuanced assessments of message content, conventional systems do not systematically construct prompt sentences that encode preprocessed linguistic features, identifier reliability signals, and desired output constraints in a unified manner. Without an explicit, structured prompt design, the interaction between the server and the generative artificial intelligence model is unstable, non-deterministic, and difficult to integrate into a robust, repeatable danger evaluation pipeline.

Third, conventional systems typically do not combine identifier-level trust evaluation, such as domain similarity or reference-based reliability scoring, with generative artificial intelligence model reasoning within a coordinated server-side architecture. As a consequence, dangerous identifiers, such as deceptive network locations or communication endpoints, may be underweighted or overlooked, and the system may either fail to detect sophisticated phishing attempts or produce excessive false positives.

Fourth, existing systems often provide only limited mechanisms for iterative improvement of the evaluation process based on actual user behavior. In particular, there is insufficient feedback control to adjust prompt content or danger determination conditions in response to user operation history (for example, user confirmations, deletions, or overrides). This lack of adaptive control prevents the system from improving its technical performance, such as precision and recall, over time for a particular deployment environment.

Therefore, there is a need for a computer-implemented technique that improves the internal operation of a server performing danger evaluation of electronic information by: (i) executing structured preprocessing and feature extraction to produce analysis target information and reliability information; (ii) generating task-specific, structured prompt sentences for a generative artificial intelligence model; (iii) obtaining structured response information that can be deterministically parsed and used in subsequent processing; and (iv) dynamically updating prompt content and danger determination conditions based on recorded evaluation results and user operation history. Such a technique would constitute an improvement in computer technology by enhancing the accuracy, robustness, and adaptability of automated danger evaluation in electronic communication systems, and by enabling the server to more efficiently convert unstructured message content into structured, actionable risk assessments.

The specific processing by the specific processing unit 290 of the data processing device 12 in Example 1 is realized by the following means.

The present invention provides a server comprising a processor configured to receive electronic information, extract character information and associated information included in the electronic information, and preprocess the character information to generate analysis target information by removing format information, normalizing character types, and performing word segmentation, to obtain word-level information, sentence-level information, and semantic information from the analysis target information using natural language processing technology and extract expression information related to danger determination, to extract identifier information from the analysis target information and the expression information, compare the identifier information with reference information stored in a storage device, and calculate reliability information, to generate a prompt sentence to be input to a generative artificial intelligence model based on the analysis target information, the expression information, and the reliability information, to instruct the generative artificial intelligence model to perform danger evaluation using the prompt sentence and determine danger degree information of the electronic information based on response information acquired from the generative artificial intelligence model, to generate evaluation result information based on the danger degree information and the response information and transmit the evaluation result information to a user information processing apparatus, and to generate notification information including warning information or handling instruction information for the electronic information according to the danger degree information indicated by the evaluation result information, and further configured to include structured instruction information in the prompt sentence requesting an output format of classification information, danger level information, and enumeration of the identifier information so as to acquire structured response information from the generative artificial intelligence model, and to record the evaluation result information in association with the user information processing apparatus and perform learning control to update at least one of content of the prompt sentence to the generative artificial intelligence model and conditions for determining the danger degree information based on the evaluation result information and operation history information of a user. This enables an improved computer-implemented danger evaluation process in which the server transforms unstructured electronic information into structured analysis target information and reliability information, interacts with the generative artificial intelligence model via explicitly structured prompt sentences to obtain machine-parseable response information, and adaptively refines prompt content and danger determination conditions based on recorded results and user behavior, thereby enhancing technical performance metrics such as detection accuracy, robustness against evolving phishing patterns, and efficiency of automated warning and handling in electronic communication systems.

The term “electronic information” refers to digital data representing a message or communication, including at least character information and associated information, which is transmitted, received, or processed by an information processing apparatus.

The term “character information” refers to textual data included in electronic information, such as letters, numerals, symbols, and other text elements that form the main content of the electronic information.

The term “associated information” refers to supplementary data related to character information, including but not limited to metadata, header information, sender information, recipient information, timestamps, and format information.

The term “format information” refers to structural or presentation data associated with character information, including markup, style attributes, layout data, and other information that affects how the character information is displayed but is not essential to its semantic content.

The term “analysis target information” refers to character information that has been preprocessed by at least one of removing format information, normalizing character types, and performing word segmentation, and that is used as an input for subsequent analysis.

The term “normalizing character types” refers to converting characters in character information into a standardized representation, including at least unifying full-width and half-width characters, case normalization, and other transformations that reduce representational variation.

The term “word segmentation” refers to processing that divides a sequence of characters into units such as words or tokens, based on language-specific rules or models, in order to facilitate linguistic analysis.

The term “natural language processing technology” refers to computational techniques for analyzing and processing human language, including at least tokenization, part-of-speech tagging, syntactic analysis, semantic analysis, and named entity recognition.

The term “word-level information” refers to information derived from analysis target information at the granularity of individual tokens or words, including token boundaries, lemmas, and part-of-speech categories.

The term “sentence-level information” refers to information derived from analysis target information at the granularity of sentences or clauses, including sentence boundaries, sentence structures, and inter-sentence relationships.

The term “semantic information” refers to information representing meanings or relationships of words and sentences in analysis target information, including concepts, intents, and contextual relations inferred by natural language processing technology.

The term “expression information related to danger determination” refers to information representing linguistic expressions, such as specific words, phrases, or constructions, that are relevant to evaluating a danger or risk associated with electronic information.

The term “identifier information” refers to data that identifies or specifies an external resource or contact point, including at least network location information, communication endpoints, and other identifiers that can be extracted from analysis target information and expression information.

The term “reference information” refers to information stored in a storage device that is used as a basis for evaluating reliability of identifier information, including at least registered identifiers, trusted sources, and historical evaluation records.

The term “reliability information” refers to information indicating a degree of trust or credibility of identifier information, calculated by comparing the identifier information with reference information.

The term “storage device” refers to a hardware or virtual component configured to store data, including at least non-volatile memory, database systems, or other computer-readable media that retain reference information and evaluation-related data.

The term “prompt sentence” refers to a sequence of characters or tokens generated to be input to a generative artificial intelligence model, the sequence specifying at least an evaluation task, context information, and desired output characteristics.

The term “generative artificial intelligence model” refers to a computational model trained by machine learning techniques to generate or output text or other data based on an input, including at least models configured to understand natural language and produce evaluation results in response to a prompt sentence.

The term “danger evaluation” refers to processing by which the generative artificial intelligence model or another evaluation mechanism assesses a degree of danger or risk associated with electronic information.

The term “danger degree information” refers to information representing a result of danger evaluation, including at least a classification, a level, or a score indicating how dangerous the electronic information is.

The term “response information” refers to data output by the generative artificial intelligence model in response to a prompt sentence, including at least classification information, explanatory information, and, when applicable, structured fields requested by the prompt sentence.

The term “evaluation result information” refers to information generated by the processor based on at least danger degree information and response information, and which is used to indicate an overall assessment of electronic information.

The term “user information processing apparatus” refers to a computing device operated by or associated with a user, including at least terminals, client devices, or other endpoints capable of receiving and presenting evaluation result information and notification information.

The term “notification information” refers to information generated for presentation to a user, including at least warning information or handling instruction information regarding electronic information.

The term “warning information” refers to information that indicates a risk or danger associated with electronic information and alerts a user to such risk or danger.

The term “handling instruction information” refers to information that suggests or specifies actions to be taken regarding electronic information, including at least deletion, quarantine, reporting, or other processing operations.

The term “structured instruction information” refers to information included in a prompt sentence that explicitly specifies an output format, required fields, or constraints for a response from a generative artificial intelligence model.

The term “classification information” refers to information indicating a categorized result of evaluating electronic information, such as safe, suspicious, or dangerous, or other discrete classes.

The term “danger level information” refers to information indicating a granular level or intensity of danger, including at least rankings or scales such as low, medium, or high.

The term “enumeration of the identifier information” refers to a representation in which multiple pieces of identifier information are listed or structured as discrete elements in an output.

The term “structured response information” refers to response information output by a generative artificial intelligence model in a predetermined, machine-parseable structure, including at least formats such as key-value pairs, lists, or other structured data representations.

The term “operation history information” refers to information representing operations performed by a user with respect to electronic information or notifications, including at least actions such as opening, deleting, reporting, or overriding warnings.

The term “learning control” refers to processing that adjusts at least one of prompt sentence content and conditions for determining danger degree information based on evaluation result information and operation history information, in order to improve evaluation performance over time.

In one embodiment, a server includes at least one processor, a memory, a storage device, and a network interface. The server is implemented, for example, on a general-purpose computer platform comprising a multi-core central processing unit, an optional graphics processing unit, a volatile memory, a non-volatile memory, and a network controller. The server executes system software such as an operating system, a mail transfer program, a mail retrieval program, and an application program implementing the functions described below.

The server uses mail server software, such as a generic Simple Mail Transfer Protocol daemon or Internet Message Access Protocol daemon, to receive electronic information including electronic mail messages from external communication networks. The server stores raw message data, including header fields and body parts, in a message repository managed by a relational database system or a file system. The server parses the raw message data to extract character information representing message body content and associated information representing metadata such as sender, recipient, timestamps, and content type.

The server executes a preprocessing module implemented in a general-purpose programming language such as Python. The server uses text-processing libraries, such as regular expression libraries and markup parsers, to remove format information including markup tags, style attributes, and layout instructions from the character information. The server normalizes character types by applying transformations such as conversion between different character widths, unification of case, and canonicalization of diacritics. The server applies word segmentation using natural language processing libraries, such as a tokenization engine, to divide the character sequence into tokens corresponding to words, subwords, or morphemes. As a result, the server generates analysis target information stored in a structured data format, for example, as a sequence of token objects each containing token text, position indices, and normalization attributes.

The server uses natural language processing technology to derive word-level information, sentence-level information, and semantic information from the analysis target information.

The server applies a syntactic parser and a part-of-speech tagger to each token sequence to assign grammatical categories and to identify phrase boundaries. The server builds an internal representation such as a dependency tree or syntax graph for each sentence, allowing the server to determine subject-predicate relationships, object relationships, and modifier structures. The server executes a semantic analyzer that maps tokens and phrases to semantic vectors using pre-trained word embeddings or contextual embeddings. The server stores the resulting information in a data structure that associates each sentence with a list of tokens, grammatical tags, semantic vectors, and syntactic relations.

The server identifies expression information related to danger determination by scanning the word-level information and sentence-level information for particular linguistic patterns. The server applies rule-based patterns and trained sequence-labeling models to detect expressions corresponding to demands for money transfers, requests for credential input, threats of account closure, and other suspicious intents. The server labels each detected phrase with a category such as “financial request,” “credential request,” or “urgency expression,” and records these categories as expression information.

The server extracts identifier information from the analysis target information and the expression information. The server uses pattern-matching rules, including regular expressions and parser-based extractors, to identify network locations, communication endpoints, and account identifiers. For example, the server detects network locations by matching uniform resource locator patterns and then parsing domain names and path elements. The server stores the extracted identifier information in a structured list, where each element contains the raw identifier string, the position in the message, and a type label such as “network location,” “telephone endpoint,” or “financial account identifier.”

The server maintains a storage device that stores reference information used to evaluate reliability of identifier information. The reference information may include a list of trusted domains, historical records of known malicious identifiers, and mappings between organizations and legitimate contact endpoints. The server compares each extracted identifier with the reference information. For example, the server computes a similarity measure between a domain name in the identifier and a set of trusted domain names by using a string distance metric or a character-level neural similarity model. The server calculates reliability information for each identifier by assigning a score that reflects closeness to trusted references or presence in a known-malicious list. The server aggregates such scores over all identifiers to produce an overall reliability measure associated with the electronic information.

The server generates a prompt sentence for a generative AI model based on the analysis target information, the expression information, and the reliability information. The server constructs the prompt sentence as a natural language instruction including (i) a description of the danger evaluation task, (ii) a presentation of relevant message content, and (iii) an explicit specification of desired outputs. In one example, the server generates a prompt sentence as follows:
“Analyze the following email for phishing or scam risk. Classify it as ‘safe,’ ‘suspicious,’ or ‘dangerous.’ Then explain briefly why, and list any dangerous links you find. Here is the email text:

### Email Body Text

Use the categories ‘safe,’ ‘suspicious,’ or ‘dangerous’ and clearly state the risk level and your reasoning.”

In another example, the server generates a prompt sentence that explicitly refers to previously computed identifier reliability:
“Consider that some links may imitate trusted sites. Analyze the email below and, for each link, state whether it appears trustworthy or deceptive. Then give an overall classification: safe, suspicious, or dangerous. Explain why.

### Email Body Text”

The server includes structured instruction information in the prompt sentence by specifying that the generative AI model should output named items such as a classification label, a danger level, a list of identifiers, and a reasoning segment. By embedding such instructions in the prompt sentence, the server causes the generative AI model to produce response information that is deterministically parseable by the server without using a separate schema negotiation.

The server implements the generative AI model using a neural network architecture such as a transformer-based sequence model. In one embodiment, the server uses a multi-layer transformer network comprising an embedding layer, multiple self-attention layers, feed-forward layers, and a final output layer configured to generate tokens sequentially. The server stores model parameters, including attention weights and feed-forward weights, in a non-volatile memory. The server has previously trained the generative AI model on a large corpus of text data using a language modeling objective function, such as minimizing cross-entropy between predicted tokens and ground-truth tokens. The server applies optimization algorithms such as stochastic gradient descent with adaptive learning rates, and uses regularization techniques such as dropout. During a fine-tuning phase, the server updates the model parameters on datasets labeled with danger categories and explanations, using cost functions that combine classification loss and language modeling loss. The server thus configures the generative AI model to produce outputs that are aligned with the danger evaluation task when provided with an appropriate prompt sentence.

The server sends the prompt sentence to the generative AI model. When the model is hosted locally, the server loads the model into system memory and executes inference on either a central processing unit or a graphics processing unit using a neural network inference framework. When the model is hosted remotely, the server transmits the prompt sentence via a network interface using a secure application protocol and receives the generated response information in return. The response information includes at least a classification label (for example, “dangerous”), a danger level indication (for example, “high”), a description of reasons, and an enumeration of suspicious identifiers extracted by the generative AI model from the prompt context.

The server determines danger degree information of the electronic information based on the response information. The server parses the response information and extracts explicit labels and values specified in the prompt sentence. The server also combines these labels with the previously computed reliability information for identifiers and with expression information. For example, the server may adjust a danger level if the generative AI model identifies a message as “suspicious” but identifier reliability scores indicate known-malicious network locations. The server stores danger degree information as a record containing at least a classification field, a numerical risk score, and a list of supporting evidence items.

The server generates evaluation result information based on the danger degree information and the response information. The evaluation result information includes a summary suitable for consumption by other software modules and by terminals. For example, the server produces a record containing classification, danger level, suspicious identifiers, relevant expressions (such as detected credential requests), and an explanatory text. The server transmits the evaluation result information to a terminal associated with a user via a communication protocol such as Hypertext Transfer Protocol over a network connection.

The terminal includes a processing unit, a memory, a display device, an input device, and a communication interface. The terminal runs a client application, such as a mail user agent or a web browser. The terminal receives the evaluation result information from the server and associates it with a corresponding electronic message in a message list. The terminal renders a user interface which presents warning information or handling instruction information according to the danger degree information indicated by the evaluation result information. For instance, the terminal displays a colored banner above the message body including text such as “This message appears dangerous. Do not click the links or provide personal information.” The terminal may also highlight specific suspicious identifiers in the message body using visual attributes such as color or underline patterns.

The user operates the terminal by viewing the presented warning information and interacting with user interface controls. The user may choose to delete the message, move it to a quarantine folder, report it for further investigation, or override the warning. The terminal records user operations as operation history information and transmits the operation history information back to the server.

The server records the evaluation result information in association with the terminal and updates a log that also stores the operation history information. The server executes a learning control module that analyzes correlations between danger degree information, response information, and user behavior. When the server detects systematic patterns, for example, that the user frequently overrides warnings for certain categories of messages, the server adjusts at least one of the content of the prompt sentence and the conditions used to map model outputs and reliability scores to danger degree levels. The server may, for example, modify the prompt sentence to request more conservative or more detailed analysis for certain message types, or change threshold values used to convert risk scores into discrete levels. By updating these parameters over time, the server adapts to the usage environment and improves technical performance metrics such as false positive rate and false negative rate.

The server improves computer technology by introducing a non-conventional interaction between structured preprocessing, identifier reliability evaluation, prompt sentence generation, and generative AI inference. The server does not simply automate human decision-making; instead, the server transforms unstructured electronic information into machine-optimal internal data structures that capture both linguistic features and identifier reliability, and uses these structures to construct prompt sentences that cause the generative AI model to output structured, machine-parseable information. This architecture reduces the need for ad hoc string parsing and fragile pattern matching in downstream processing, thereby decreasing computational overhead and error-prone logic.

The server reduces processing time and communication load by filtering and summarizing message content before sending it to the generative AI model. Because the server includes only relevant analysis target information and expression information in the prompt sentence, the amount of text processed by the model is reduced compared to sending entire message threads without preprocessing. This reduction decreases inference latency and improves throughput when the server processes large volumes of messages. Additionally, by instructing the model to output structured response information in a predetermined format, the server eliminates complex post-processing and reduces the number of network round trips required for clarification or additional queries.

The server achieves improved accuracy and robustness by combining multiple technical mechanisms that are not routinely combined in conventional systems. The server uses natural language processing algorithms to generate semantic features, applies identifier reliability scoring based on stored reference information, constructs prompt sentences encoding explicit output expectations, and integrates generative AI responses into a controlled danger evaluation logic. This combination produces a more precise mapping from message characteristics to risk assessments than either rule-based filtering or simple discriminative classification alone. Because the server's learning control continuously updates prompt content and mapping conditions based on recorded evaluation results and user behavior, the system adapts to novel attack patterns while maintaining stable operation.

In various alternative embodiments, the server can employ different neural network architectures as the generative AI model, such as encoder-decoder transformers, recurrent neural networks with attention, or hybrid architectures combining convolution and attention layers. The server can also use different forms of identifier reliability scoring, including graph-based trust propagation over networks of domains or communication endpoints. The server can modify the structure of prompt sentences to request additional fields such as confidence intervals, recommended user actions, or risk rationales formatted as bullet points. The server can further combine generative AI model outputs with discriminative classifiers, such as models based on bidirectional encoder representations or lightweight convolutional text classifiers, where such classifiers consume the same analysis target information and expression information in parallel with the generative AI model.

The terminal can present evaluation result information using various interface modalities, including textual warnings, graphical icons, audio alerts, or haptic feedback, and can enforce handling instruction information by disabling direct activation of suspicious identifiers until explicit user confirmation is received. In some embodiments, the terminal may also pre-filter messages displayed to the user based on danger degree information, thereby reducing cognitive load and focusing user attention on higher-priority items. Through these configurations, the server, the terminal, and the user cooperate in a manner that yields an overall improvement in the operation of a computer-based communication system. The server's integration of structured preprocessing, prompt sentence generation, and adaptive learning control enables faster, more accurate, and more efficient detection and presentation of dangerous electronic information than conventional systems that rely solely on fixed rules or unstructured interaction with machine learning models.

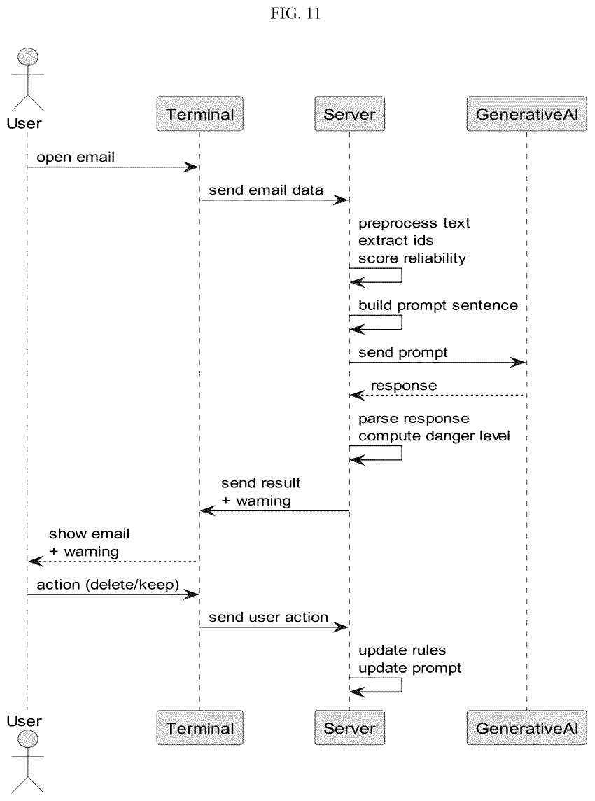

The following describes the processing flow using FIG. 11.

### Step 1

The server receives electronic information via a mail transfer protocol or an application protocol.

The server uses a mail server component to accept a raw message as input, the raw message including header fields and body parts encoded in a standard message format. The server parses the raw message and extracts character information (textual body content) and associated information (metadata such as sender, recipient, timestamps, and content type) as output.

The server performs this extraction by reading the message headers, decoding transfer encodings, selecting the main text or HTML part, and converting the body into an internal text string together with a metadata record.

### Step 2 The server preprocesses the extracted character information to generate analysis target

information.

The server takes the character information string as input and applies text-processing routines that remove format information such as markup tags and style attributes, normalize character types, and perform basic cleanup.

The server outputs analysis target information represented as a normalized text string in which unnecessary formatting has been removed and characters have been converted into a consistent representation.

The server performs this processing using a scripting language and libraries for regular expression matching and markup parsing, iterating over the text to strip tags, convert character widths, unify case, and remove control characters.

### Step 3

The server performs word segmentation on the analysis target information.

The server receives the normalized text string as input and applies a tokenizer appropriate for the language, dividing the text into units such as words, subwords, or morphemes.

The server outputs a token sequence, where each token object includes token text, start and end positions, and normalization attributes. The server uses a natural language processing library to scan the text, detect token boundaries (for example, at whitespace or language-specific segmentation points), and create a list or array of token structures stored in memory.

### Step 4

The server derives word-level information and sentence-level information from the token sequence.

The server uses the token sequence as input and applies sentence boundary detection algorithms and part-of-speech tagging.

The server outputs a data structure in which tokens are grouped into sentences, each token is annotated with a part-of-speech tag, and sentence boundaries are marked by indices. The server runs a sentence splitter to identify sentence-ending punctuation or language-specific boundary patterns, then feeds each sentence into a tagger that assigns grammatical categories by consulting statistical models or neural tagging models.

### Step 5

The server generates semantic information and expression information related to danger determination.

The server takes the sentence-annotated token data as input and applies a syntactic parser and a semantic encoder to compute semantic vectors for tokens and phrases.

The server outputs semantic information, such as embeddings for sentences and phrases, and expression information, such as labeled phrases indicating money requests, credential requests, or urgency expressions.

The server executes a dependency parser to build syntax trees, then passes sentence representations through a semantic encoding model, such as a transformer encoder, and applies pattern rules or sequence-labeling models to detect and label suspicious expressions.

### Step 6

The server extracts identifier information from the analysis target information and the expression information.

The server uses the normalized text and token boundaries as input, and applies pattern-based extractors to identify network locations, communication endpoints, and account identifiers.

The server outputs a list of identifier elements, each including the raw identifier string, type label, and position indices.

The server executes regular expression matching to find patterns resembling network addresses or numerical identifiers, validates them using parsers (for example, a uniform resource locator parser), and constructs structured entries for each detected identifier.

### Step 7

The server evaluates reliability information for the identifier information using reference information stored in a storage device.

The server receives the list of identifier elements as input and accesses reference information such as trusted identifiers and known-malicious identifiers from a database.

The server outputs reliability information, including a numeric reliability score or category for each identifier and an aggregated reliability measure for the entire message.

The server computes similarity between identifiers and trusted references using string distance functions or learned similarity models, checks membership against blacklists, and combines these results by weighted averaging or rule-based logic to produce reliability scores.

### Step 8

The server constructs a prompt sentence for a generative AI model based on analysis target information, expression information, and reliability information.

The server uses as input the normalized text, the list of suspicious expressions, and the computed reliability scores, and composes a natural language instruction string that includes these elements in a condensed form.

The server outputs a prompt sentence that specifies the evaluation task, relevant context, and required output items. The server assembles the prompt by inserting the email text and summary features into a

template, for example: “Analyze the following email for phishing or scam risk. Classify it as ‘safe,’ ‘suspicious,’ or ‘dangerous.’ Then explain briefly why, and list any dangerous links you find. Here is the email text: [EMAIL BODY TEXT].”

### Step 9

The server augments the prompt sentence with structured instruction information to obtain structured response information.

The server takes the initial prompt sentence as input and appends explicit directions regarding output format, such as naming required fields and labels.

The server outputs an enhanced prompt sentence that requests classification information, danger level information, and enumeration of identifier information in a consistent structure. The server modifies the prompt by adding sentences like “Use the categories ‘safe,’ ‘suspicious,’ or ‘dangerous’ and clearly state the risk level and list each suspicious link separately,” thereby guiding the generative AI model toward producing machine-parseable output.

### Step 10

The server sends the enhanced prompt sentence to the generative AI model and obtains response information.

The server uses the enhanced prompt sentence as input to an inference engine that implements a transformer-based generative model stored in memory or accessed via a network interface.

The server outputs response information, including a classification label, a danger level description, reasoning text, and a list of identifiers identified as suspicious by the model.

The server feeds the prompt tokens to the generative AI model, performs forward passes through embedding layers and attention layers, decodes generated tokens until an end condition is reached, and assembles the generated tokens into a response string for further parsing.

### Step 11

The server parses the response information and determines danger degree information.

The server uses the response string as input and extracts the classification label, danger level, and enumerated identifiers by searching for predefined keywords and patterns specified in the prompt.

The server outputs structured danger degree information, including at least a discrete danger class and a numerical risk score that may be derived from mapping textual labels to numeric values.

The server applies string analysis to locate labeled segments (for example, lines starting with “Classification:” or explicit words such as “dangerous”), converts them to internal codes, and optionally adjusts the danger degree using the previously computed reliability information for identifiers.

### Step 12

The server generates evaluation result information based on danger degree information and response information.

The server takes as input the structured danger degree information, the parsed reasoning text, and the list of suspicious identifiers.

The server outputs evaluation result information in a compact internal format, such as a record including classification, danger level, suspicious identifiers, and explanation.

The server assembles this record by populating fields with values from the parsed response and the reliability analysis, and stores the record in a database or memory buffer for subsequent transmission.

### Step 13

The server transmits evaluation result information to the terminal and generates notification information.

The server uses the evaluation result record and a mapping to a specific electronic message as input, and prepares a message or data packet for the terminal that contains both raw evaluation results and user-facing notification text.

The server outputs a notification payload including warning information or handling instruction information according to the danger degree.

The server formats the payload as a response in a client-server protocol or as metadata associated with the message, and includes a warning string such as “This email appears dangerous. Do not click the links or provide personal information.”

### Step 14

The terminal receives the evaluation result information and presents notification information to the user.

The terminal uses the notification payload and local message data as input, and updates a user interface that displays the corresponding electronic message.

The terminal outputs a rendered view containing the message content together with visual indicators, such as colored banners, icons, or highlighted identifiers, that convey the danger degree and recommended actions.

The terminal parses the payload, associates its identifiers with positions in the displayed message, and draws warning elements and overlays on the display device.

### Step 15

The user interacts with the terminal based on the notification information.

The user uses the displayed warning and message content as input for a decision and operates controls such as buttons or menu items to delete, move, or retain the message.

The user's actions result in operation history information as output, which is recorded by the terminal and sent back to the server.

The user may, for example, select “Delete this email” in response to a “dangerous” rating, or select “This is safe” to override a warning, thereby generating explicit feedback signals.

### Step 16

The server records the evaluation result information together with operation history information and performs learning control.

The server uses past evaluation result records and corresponding user operation histories as input to a learning module that adjusts system parameters.

The server outputs updated parameters, including modified prompt sentence templates and revised thresholds or rules for mapping classification labels and reliability scores to danger degree levels.

The server analyzes patterns such as frequent overrides or consistent user agreement, computes performance metrics over time, and updates stored configuration values so that subsequent evaluations use improved prompts and decision criteria, thereby refining accuracy and robustness of the danger evaluation process.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern communication environments, electronic communications such as electronic mail and messages increasingly include malicious content attempting to steal authentication information, induce fraudulent payments, or distribute harmful code. Conventional filtering technologies typically rely on static rules or single-model machine learning approaches that analyze message text or header information. Such approaches often suffer from limited adaptability to new attack patterns, high false positive and false negative rates, and insufficient ability to provide understandable explanations to users regarding why a particular communication is dangerous. Furthermore, conventional systems generally do not effectively combine multiple heterogeneous evaluation mechanisms, such as statistical learning models and generative AI models, in a coordinated manner to produce a robust and transparent danger assessment.

Another issue with existing systems is that they frequently treat machine learning outputs as opaque scores without explicitly integrating them with higher-level semantic reasoning. As a result, conventional systems lack a structured mechanism for constructing prompts to generative AI models that fully leverage pre-extracted features and preliminary risk scores, and they fail to obtain structured, machine-usable explanations from such models. This limits the system's ability to generate precise, user-facing warnings that highlight specific dangerous elements in a communication and recommend appropriate user actions.

In addition, known systems often do not maintain an effective feedback loop between quarantined communications, user feedback, and the underlying models. While some systems may log spam or phishing messages, they typically do not systematically use quarantined data and explicit user feedback to update both statistical learning models and the prompt generation logic used with generative AI models. Consequently, conventional systems do not adequately improve detection accuracy and robustness over time in response to evolving threats and real-world usage. Accordingly, there is a need for an improved computer-implemented system that (i)

integrates natural language processing-based feature extraction, statistical learning-based preliminary scoring, and generative AI-based semantic evaluation, (ii) constructs and uses prompt sentences in a structured manner to obtain detailed and structured danger assessments from a generative AI model, (iii) automatically classifies electronic communications into multiple danger categories, issues user-readable warnings, and performs quarantine operations, and (iv) continuously refines its models and prompt generation rules based on quarantined data and user feedback. Such a system should improve the technical functioning of the computer-based filtering process itself by enhancing detection accuracy, interpretability, adaptability, and efficiency of electronic communication risk evaluation.

The specific processing by the specific processing unit 290 of the data processing device 12 in Application Example 1 is realized by the following means.

The present invention provides a server comprising a processor configured to acquire electronic communications, extract and structure body information, sender information, recipient information, and associated information as internal data; perform natural language preprocessing on the body information to conduct sentence segmentation, tokenization, normalization, detection of language anomalies, and extraction of feature information including credential input request expressions, monetary request expressions, urgency expressions, identification information, and attribute information corresponding to the identification information; convert the body information and the feature information into a numerical feature vector and calculate a first risk evaluation value of the electronic communication by using a statistical learning model; generate a prompt sentence to be input to a generative AI model based on the feature information and the first risk evaluation value, transmit the prompt sentence to the generative AI model, and acquire from the generative AI model a second risk evaluation value and explanation information relating to the electronic communication; determine a final danger category of the electronic communication based on the first risk evaluation value, the second risk evaluation value, and the feature information, and classify the electronic communication as at least one of a safe communication, an attention-required communication, and a harmful communication; generate notification information including warning information, explanation information for dangerous portions, and recommended action information for communications classified as the attention-required communication or the harmful communication, transmit the notification information to a user terminal, move the corresponding electronic communications into a quarantine storage area different from a normal storage area, and assign access control information to the quarantined communications; and store quarantined communications and user feedback information as learning data and update the statistical learning model and generation rules of the prompt sentence so as to improve future risk evaluation accuracy. This enables the server to technically improve the operation of electronic communication filtering by coordinating rule-based and statistical feature analysis with generative AI-based semantic evaluation, by producing structured and explainable danger assessments, by automatically executing quarantine and access control based on multi-source risk determinations, and by continuously adapting the underlying models and prompt construction logic using real-world quarantined data and user feedback, thereby enhancing accuracy, robustness, and transparency of malicious communication detection in a computer network environment.

The term “electronic communication” refers to any digitally transmitted message or data unit, including but not limited to electronic mail, short messages, instant messages, or similar text-based communications exchanged over a communication network.

The term “user terminal” refers to any information processing apparatus operated by a user, including but not limited to a personal computer, a mobile communication device, a tablet device, or any other network-enabled client device capable of sending and receiving electronic communications.

The term “body information” refers to textual content or equivalent message content contained in an electronic communication, including plain text, text extracted from structured formats, or text derived from markup language representations.

The term “sender information” refers to data elements included in an electronic communication that identify a source of the communication, such as sender addresses, identifiers, or account-related metadata.

The term “recipient information” refers to data elements included in an electronic communication that identify a destination or intended receiver of the communication, such as recipient addresses, identifiers, or account-related metadata.

The term “associated information” refers to metadata and supplementary data related to an electronic communication, including but not limited to subject fields, header fields, timestamps, routing information, and protocol-specific control information.

The term “internal data” refers to structured data representations generated within the system by parsing and transforming elements of an electronic communication for purposes of analysis and processing.

The term “natural language preprocessing” refers to a sequence of computational operations applied to human-readable text to prepare it for analysis, including but not limited to sentence segmentation, tokenization, normalization, and detection of language anomalies.

The term “sentence segmentation” refers to a process of dividing continuous text into individual sentence units based on linguistic or formatting cues.

The term “tokenization” refers to a process of segmenting text into smaller units such as words, subwords, or symbols that serve as atomic elements for further analysis.

The term “normalization” refers to a process of converting text into a standardized form, including operations such as case conversion, whitespace reduction, and character normalization.

The term “language anomaly” refers to an expression or pattern in text that deviates from typical linguistic norms, including grammatical errors, unnatural phrasing, inconsistent style, or unusual word order suggestive of suspicious or low-quality composition.

The term “feature information” refers to a set of extracted attributes derived from body information and associated information, including specific expressions, patterns, and metadata used as input to risk evaluation processes.

The term “credential input request expression” refers to a textual expression or phrase that explicitly or implicitly requests entry or disclosure of authentication data, such as passwords, personal identification numbers, or account credentials.

The term “monetary request expression” refers to a textual expression or phrase that requests a transfer of money, payment of funds, provision of financial information, or execution of a financial transaction.

The term “urgency expression” refers to a textual expression or phrase that indicates time pressure, threat of negative consequence, or immediate action requirements, such as warnings that an account will be locked or suspended unless prompt action is taken.

The term “identification information” refers to data elements embedded in an electronic communication that specify a point of contact or resource, such as network resource locators, communication numbers, or electronic addresses.

The term “attribute information” refers to classification data or descriptive labels associated with identification information, such as indicators of domain type, geographic region, known reputation status, or communication channel category.

The term “numerical feature vector” refers to a multi-dimensional numeric representation of text and feature information suitable for input to a statistical or machine learning model.

The term “statistical learning model” refers to a computational model trained on historical data to infer patterns and make predictions, including but not limited to classification models, regression models, and ensemble models implemented by statistical or machine learning techniques.

The term “first risk evaluation value” refers to a quantitative indication of a danger level of an electronic communication computed by the statistical learning model based on the numerical feature vector.

The term “generative AI model” refers to a machine learning model that generates output content or predictions, including text or structured data, in response to input instructions, and that is capable of performing semantic analysis of electronic communications.

The term “prompt sentence” refers to a textual instruction or input sequence provided to a generative AI model, which includes context information, feature information, and evaluation values for the purpose of obtaining an assessment of the risk of an electronic communication.

The term “second risk evaluation value” refers to a quantitative indication of a danger level of an electronic communication generated by the generative AI model in response to a prompt sentence.

The term “explanation information” refers to descriptive data output by the generative AI model or the system that indicates reasons, contributing factors, or specific elements underlying a risk evaluation.

The term “final danger category” refers to a classification result representing an overall danger level of an electronic communication, determined by combining multiple evaluation values and feature information.

The term “safe communication” refers to an electronic communication that is classified as having a sufficiently low danger level and not requiring special caution or quarantine.

The term “attention-required communication” refers to an electronic communication that is classified as requiring user attention or caution due to a moderate or uncertain danger level.

The term “harmful communication” refers to an electronic communication that is classified as presenting a high danger level, such as suspected fraudulent, phishing, or malicious content.

The term “notification information” refers to data generated by the system for presentation to a user, including warning messages, explanations of dangerous portions, and recommended user actions.

The term “warning information” refers to a part of the notification information that alerts a user to potential risk or harmful characteristics of an electronic communication.

The term “recommended action information” refers to a part of the notification information that suggests specific actions for the user to take or avoid in response to an assessed danger level.

The term “normal storage area” refers to a logical or physical data storage region in which electronic communications judged to be non-harmful are stored for ordinary access by a user.

The term “quarantine storage area” refers to a logical or physical data storage region separate from the normal storage area in which electronic communications classified as harmful or attention-required are stored with restricted or controlled access.

The term “access control information” refers to metadata or control parameters associated with stored electronic communications that define permitted operations, access rights, or interaction constraints for such communications.

The term “feedback information” refers to data received from a user that reflects user judgments or actions relating to the classification of electronic communications, including confirmations, corrections, or reports of misclassification.

The term “learning data” refers to data used to train or update models in the system, including quarantined communications, associated labels, evaluation values, and feedback information.

The term “generation rules of the prompt sentence” refers to rules, templates, or algorithms governing the composition, structure, and content of prompt sentences to be supplied to a generative AI model.

The term “risk evaluation accuracy” refers to a degree to which risk evaluation values and danger categories produced by the system correctly reflect actual danger levels of electronic communications, as measured by performance metrics such as error rates, detection rates, or false positive and false negative rates.

In one embodiment, a server implements the claimed system as a network-connected electronic information processing apparatus. The server comprises at least one hardware processor, a main memory, a non-volatile storage device, a network interface, and an operating system such as a general-purpose server operating system. The server executes application software implemented, for example, in a high-level programming language such as a scripting language or a compiled language. The server is connected via the network interface to one or more terminals operated by users. Each terminal may be a personal computer, a mobile communication device, or a tablet device executing a mail client or a dedicated application.

The server stores program modules in the non-volatile storage device. These program modules include a communication acquisition module, a text preprocessing module, a feature extraction module, a statistical learning inference module, a generative AI interface module, a danger integration module, a quarantine management module, a notification generation module, and a model update module. The server loads these modules into the main memory and executes them on the processor. Each module operates on specific data structures stored in the main memory, such as message records, feature vectors, evaluation records, and user feedback records.

The server acquires electronic communications via a message transfer protocol or an application programming interface. When the server receives a new electronic communication from a terminal, the server stores the raw message in a message store implemented, for example, as a structured file system or a relational database table. The server parses the raw communication into an internal message record, which includes fields for body information, sender information, recipient information, and associated information. For example, the server maps header fields, such as source address, destination address, subject, and timestamp, into predefined columns in the message record. The server also stores the raw body content, including plain text segments and markup language segments, as separate attributes.

The server uses a text preprocessing module to normalize and annotate the body information. The server applies a markup parser, such as an HTML parsing library, to remove tags, scripts, and embedded formatting, and to extract plain text. The server then uses a natural language processing toolkit, such as a tokenization and segmentation library, to segment the text into sentences and tokens. The server converts the text to a normalized representation by performing case folding, whitespace normalization, and character normalization. The server records tokens, sentence boundaries, and part-of-speech tags in an internal data structure such as an array of token objects, where each token object contains a surface form, a normalized form, and syntactic annotations.

The server uses the feature extraction module to detect specific expressions and patterns from the preprocessed text. The server applies pattern-matching functions, such as regular expression engines, to identify credential input request expressions (for example, phrases equivalent to “enter your password” or “verify your login information”), monetary request expressions (for example, phrases equivalent to “send money” or “update your payment information”), and urgency expressions (for example, phrases equivalent to “your account will be locked” or “immediate action required”). The server also extracts identification information, such as network resource locators, communication numbers, and electronic addresses, by applying regular expressions and parsing routines. The server associates each extracted element with attribute information, such as a category label, a coarse-grained domain type, or a reputation score retrieved from an external reputation database.

The server evaluates language anomalies by using either a rule-based grammar checker or a language model. In one embodiment, the server maintains a statistical language model built using n-gram probabilities or a recurrent neural network. The server computes a per-sentence anomaly score based on the probability of the token sequence under the language model. If the score falls below a threshold, the server marks the sentence as anomalous. In another embodiment, the server uses a transformer-based encoder that produces an anomaly score using a trained classifier head. The server stores a language anomaly flag in the feature set when the proportion of anomalous sentences exceeds a predetermined threshold.

The server represents the extracted feature information in a structured format, such as a feature record containing boolean flags (presence of credential request, presence of suspicious network resource locator, presence of urgency expression, presence of language anomaly) and categorical attributes (resource locator category, sender domain category). The server then converts the body information and the feature record into a numerical feature vector. In one embodiment, the server applies a term frequency-inverse document frequency vectorizer to the normalized body text to obtain a sparse numerical representation of textual content. The server concatenates this representation with one-hot encoded feature fields corresponding to the extracted flags and attributes, resulting in a high-dimensional feature vector. The server uses a statistical learning model to compute a first risk evaluation value. In one example, the server uses a logistic regression classifier trained on historical labeled communications, where each training record contains a feature vector and a label indicating whether the communication is harmful or safe. The server stores model parameters, such as weight vectors and bias terms, in the non-volatile storage device. At runtime, the server loads these parameters into memory and applies a matrix-vector multiplication to the feature vector, followed by a logistic function, to obtain a probability value representing the risk that the communication is harmful. In another example, the server uses an ensemble model such as a gradient boosting classifier with decision trees, where the server traverses decision trees in sequence to produce an aggregated score. The server stores the resulting probability or score as the first risk evaluation value, and also stores the predicted label as an intermediate classification.

The server then interfaces with a generative AI model to obtain a second risk evaluation value and explanation information. In one embodiment, the generative AI model has a transformer-based neural network architecture comprising multiple self-attention layers, feed-forward layers, and normalization layers. The model is trained beforehand on large-scale text data to learn general language representations and then adapted to security classification and explanation tasks by fine-tuning on a dataset of annotated electronic communications. The server does not retrain this model during normal operation, but the server sends prompt sentences and receives model outputs via an application programming interface.

The server constructs a prompt sentence by combining the most relevant parts of the body information, the feature information, and the first risk evaluation value. The server includes, for example, a truncated version of the body text, a list of extracted phrases, a list of network resource locators, and an explicit numeric mention of the first risk evaluation value. The server uses a template to ensure consistent structure. For example, the server may generate a prompt sentence such as:
“You are a security analysis assistant. Analyze the following email text and determine whether it is dangerous (for example, phishing or fraud).

### Email Body

‘Dear user, your account will be locked. Please click the following link and enter your password to continue: http://example-verify-login.cn’ Extracted phrases: [‘account will be locked’, ‘enter your password’, ‘http://example-verify-login.cn’]

Preliminary risk score: 0.91

Provide: (1) a label ‘dangerous’or ‘safe’, (2) a risk score from 0 to 100, and (3) a brief explanation of the main risk factors.”

In another example, the server may use a prompt sentence of the following form:
“Act as an email security filter. Read the email content below and decide if it should be treated as a harmful communication.

### Email Body

‘Your payment information needs to be verified. Please confirm your credit card details using the link below.’

Extracted phrases: [‘payment information needs to be verified’, ‘confirm your credit card details’]

Preliminary risk score: 0.87

Return your answer in plain English, including a classification (‘dangerous’ or ‘safe’), a risk score (0-100), and a list of dangerous phrases you detected.”

The server transmits the prompt sentence to the generative AI model over a secure communication channel using the network interface. The server sets parameters such as maximum response length and temperature to ensure deterministic and concise output. The model internally processes the tokenized prompt through its attention layers and outputs a textual response that contains a classification label, a numeric risk score, and an explanation. The server parses the response according to predetermined patterns to extract the second risk evaluation value and explanation information. By explicitly structuring the prompt sentence and parsing logic, the server enforces a predictable data flow between its internal feature-based evaluation and the generative AI model's semantic evaluation.

The server integrates the first and second risk evaluation values using the danger integration module. For example, the server may compute a combined risk value as a weighted sum of the first risk evaluation value and a normalized version of the second risk evaluation value.

The server may adjust the weights based on reliability statistics observed during validation.

The server also examines the explanation information to detect specific risk indicators, such as explicit mentions of phishing or credential theft. The server then determines the final danger category by comparing the combined risk value to multiple thresholds and by checking rule-based conditions derived from both the feature information and the generative explanation. For instance, if the combined risk value exceeds a high threshold and the explanation mentions credential theft, the server classifies the communication as a harmful communication; if the combined risk value is moderate and the explanation is uncertain, the server classifies the communication as an attention-required communication; otherwise, the server classifies the communication as a safe communication.

The server associates the final danger category with the stored message record and updates the data structures in the message store. For communications classified as harmful or attention-required, the server generates notification information including warning information and recommended actions. The notification information may comprise a brief warning sentence, one or more highlighted dangerous phrases extracted from the explanation information, and suggested operations such as “do not click the link” or “do not enter any password.” The server stores this notification information in a notification record linked to the message record.

The server controls storage locations by moving harmful or attention-required communications into a quarantine storage area. The quarantine storage area is implemented as a separate logical folder or table with restricted access permissions. When the server moves a communication into this area, the server sets access control information that disables certain operations by default, such as automatic rendering of embedded content or direct execution of attachments. The server thus controls real hardware and software resources, including storage devices and execution policies, to physically and logically isolate potentially harmful content. This isolation reduces the risk that malicious content triggers unintended operations on the terminal.

The terminal periodically retrieves message metadata and notification information from the server. When the terminal retrieves an email classified as harmful or attention-required, the terminal displays the warning information prominently in the user interface. The terminal may show a banner indicating that the email is dangerous and may disable direct activation of embedded network resource locators unless the user performs an explicit confirmation. The terminal thereby cooperates with the server to implement technical protections at the user interface and execution environment level.

The user may provide feedback through the terminal. For example, if the user recognizes that an email classified as harmful is actually safe, the user can select a control indicating that the classification is incorrect. Conversely, if the user receives an email that is not flagged but appears dangerous, the user can report it as harmful. The terminal sends this feedback information, including the message identifier and the user's evaluation, back to the server. The server accumulates quarantined communications and user feedback information as learning data in a dedicated training datastore. Periodically, the server invokes the model update module to improve the statistical learning model and the generation rules for prompt sentences. For the statistical learning model, the server partitions the accumulated data into training and validation subsets. The server regenerates feature vectors for the training subset and retrains the classifier using a supervised learning algorithm such as gradient descent-based optimization. The server defines a loss function, for example, cross-entropy loss between predicted probabilities and true labels, and updates the model parameters by computing gradients and adjusting weights iteratively. The server uses early stopping and validation metrics, such as area under the ROC curve or F1-score, to select the best-performing model. The server then replaces the previously deployed model parameters in the statistical learning inference module with the updated parameters.

For the prompt generation logic, the server analyzes historical records of prompt sentences and generative AI outputs to identify patterns that lead to more accurate second risk evaluation values. For example, the server may determine that including specific extracted features, such as the list of network resource locators, consistently improves alignment between model output and ground truth. The server therefore modifies the prompt template to include additional feature descriptions or to specify more explicit instructions to the generative AI model. By updating the generation rules in this data-driven manner, the server improves the consistency and informativeness of the generative AI output over time.

In some embodiments, the server additionally trains or fine-tunes a smaller neural network that predicts an optimal weight for combining the first and second risk evaluation values, based on input features such as sender domain reputation and model confidence estimates. This neural network may be a shallow fully connected network with one or two hidden layers, using rectified linear units and regularization techniques. The server trains this combination network by minimizing a loss function that measures classification error on historical labeled data. This additional optimization step further increases overall detection accuracy and reduces false positives and false negatives.

The technical effect of the described architecture is that the server improves the internal operation of the computer-based filtering system. By structuring message data into explicit feature vectors and evaluation records, and by using a coordinated multi-model approach, the server achieves more accurate and robust risk assessments than conventional systems that rely on a single classifier or static rules. The explicit use of a prompt sentence that incorporates precomputed features and a preliminary risk score allows the generative AI model to focus on high-risk elements, thereby reducing computational overhead and response variation. The combination of a statistical learning model and a generative AI model produces complementary strengths: the former provides fast, stable scoring based on high-dimensional features, while the latter supplies semantic understanding and human-readable explanations. This combination reduces misclassification errors and provides users with clear justifications for warnings.

Furthermore, the quarantine storage mechanism and access control information directly control physical and logical resources, leading to reduced exposure of terminals to harmful content. The feedback-driven model update process allows the server to adapt to new attack patterns without manual rule updates, improving long-term resilience. These operations go beyond mere automation of manual review and instead modify core computational data flows, model parameters, and storage behaviors in a way that increases processing speed, accuracy, and safety. By organizing data structures, algorithms, and network interactions in the described manner, the server achieves an improvement in computer technology itself, specifically in the technical field of secure electronic communication processing.

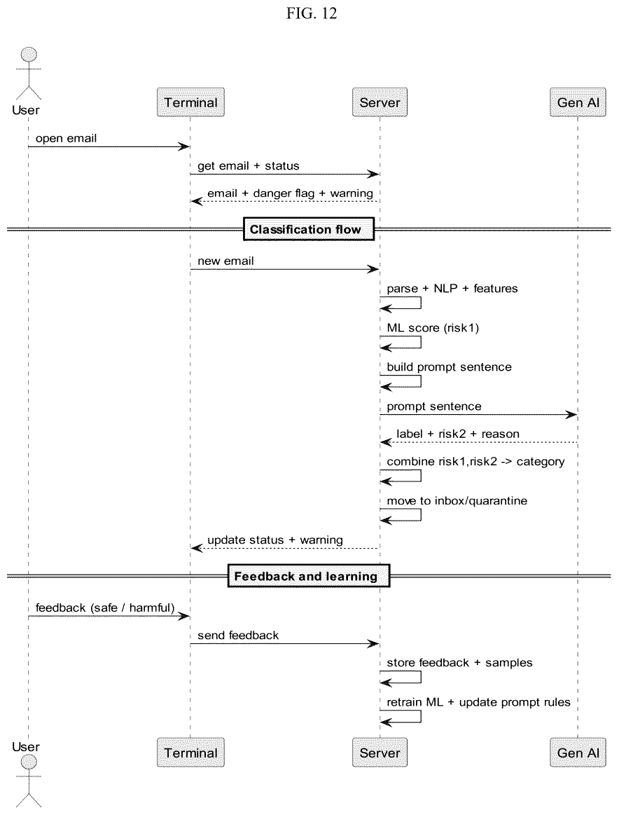

The following describes the processing flow using FIG. 12.

### Step 1

The server receives an electronic communication from the terminal and stores it.

The input is a raw message stream including headers and body, transmitted over a network protocol.

The server writes the raw message into a message store and assigns a unique message identifier.

The output is a stored raw message record indexed by the message identifier.

### Step 2

The server parses the raw message into structured internal data.

The input is the stored raw message record.

The server extracts header fields such as sender information, recipient information, subject, and timestamp, and separates body information from header information.

The server converts markup-based body segments into plain text using a markup parser and stores the results in a message record structure. The output is a structured message record containing body information, sender information,

recipient information, and associated information.

### Step 3

The server performs natural language preprocessing on the body information.

The input is the body text contained in the structured message record.

The server segments the text into sentences, tokenizes the text into words or subwords, normalizes the characters (for example, lowercasing and whitespace normalization), and attaches basic linguistic annotations.

The server writes the token list and sentence boundaries back into the message record.

The output is an annotated text representation linked to the same message identifier.

### Step 4

The server extracts feature information from the annotated text.

The input is the annotated text representation.

The server applies pattern-matching rules and regular expressions to detect credential input request expressions, monetary request expressions, urgency expressions, and identification information such as network resource locators and communication numbers.

The server assigns attribute information, such as category labels, to each detected element and sets boolean flags indicating the presence of each category.

The output is a feature record containing extracted phrases, flags, and attribute information associated with the message.

### Step 5:

The server evauates language anomalies in the body text.

The input is the annotated text representation.

The server computes anomaly scores for sentences using a language model or rule-based grammar checks and compares the scores with a threshold.

The server sets a language anomaly flag in the feature record if the number or proportion of anomalous sentences exceeds a predefined limit.

The output is an updated feature record that includes a language anomaly indicator.

### Step 6

The server generates a numerical feature vector for statistical learning.

The input is the body text and the updated feature record.

The server applies a text vectorization method, such as term frequency-inverse document frequency, to the body text to generate a numeric representation of term usage.

The server encodes the feature flags and categorical attributes into numeric values and concatenates them with the text vector.

The output is a numerical feature vector representing the message content and extracted features.

### Step 7

The server computes a first risk evaluation value using a statistical learning model.

The input is the numerical feature vector.

The server loads a trained classification model and performs inference by applying the model parameters to the feature vector, for example by matrix multiplication and activation functions.

The server calculates a probability or score that indicates the risk level of the message and stores this as the first risk evaluation value.

The output is the first risk evaluation value and, optionally, a preliminary classification label linked to the message.

### Step 8

The server constructs a prompt sentence for a generative AI model.

The input is the body text, the feature record, and the first risk evaluation value.

The server selects important parts of the body text, such as dangerous-looking phrases or truncated content, and formats them into a template.

The server inserts the extracted phrases, identification information, and the first risk evaluation value into the template to form a coherent instruction sentence.

The output is a structured prompt sentence ready to be transmitted to the generative AI model.

### Step 9

The server sends the prompt sentence to the generative AI model and receives a response.

The input is the generated prompt sentence. The server transmits the prompt sentence over a network interface to an inference service

hosting the generative AI model and sets inference parameters such as maximum tokens. The generative AI model returns a textual response including a classification (for example, “dangerous” or “safe”), a numeric risk score, and an explanation of risk factors.

The output is a model response string associated with the message.

### Step 10

The server parses the generative AI model response into structured evaluation data.

The input is the model response string.

The server applies pattern matching or simple parsing rules to extract the second risk evaluation value, a danger label, and explanation information from the response.

The server stores these values in an evaluation record linked to the message identifier.

The output is an evaluation record containing the second risk evaluation value, a danger label, and explanation information.

### Step 11

The server integrates the first and second risk evaluation values to determine a final danger category.

The input is the first risk evaluation value, the second risk evaluation value, the danger label, and the feature record.

The server computes a combined score using a predetermined combination rule, such as a weighted sum or decision rule set, and compares the combined score with multiple thresholds.

The server also checks specific conditions, such as the presence of credential request expressions and explicit mentions in the explanation information, to adjust the decision.

The output is a final danger category assigned to the message, such as safe communication, attention-required communication, or harmful communication.

### Step 12

The server updates the message storage state based on the final danger category.

The input is the final danger category and the message identifier.

The server writes the danger category into the message record and, if the category is attention-required or harmful, moves the message from a normal storage area to a quarantine storage area.

The server sets access control information for the quarantined message to restrict automatic loading of embedded content and attachments.

The output is an updated storage state for the message and associated access control settings.

### Step 13

The server generates notification information for the terminal.

The input is the final danger category, the explanation information, and key extracted features.

The server composes warning text describing the risk level, highlights specific dangerous phrases, and lists recommended user actions.

The server packs this information into a notification record associated with the message identifier.

The output is structured notification information ready to be transmitted to the terminal.

### Step 14

The server transmits message metadata and notification information to the terminal.

The input is the message identifier, the classification result, and the notification record.

The server sends the classification flags and notification text to the terminal over a communication protocol, together with references to the stored message.

The output is delivery of security metadata and warning content to the terminal.

### Step 15

The terminal displays the message and associated warning to the user.

The input is the classification flags, the warning text, and the message reference from the server.

The terminal renders the message list with visual indicators based on the danger category and displays the warning text when the user opens or previews the message.

The terminal may disable direct activation of links or attachments by default for quarantined or attention-required messages. The output is a user interface view presenting the message and its danger status.

### Step 16

The user reviews the warning and interacts with the message.

The input is the displayed message and the warning content.

The user decides whether to trust, delete, or report the message, and may operate controls such as “mark as safe” or “report as harmful.”

The user action generates feedback that reflects the user's evaluation of the system's classification.

The output is user feedback indicating agreement or disagreement with the danger category.

### Step 17

The terminal sends user feedback to the server.

The input is the user's selection (for example, “false positive” or “missed threat”) and the message identifier.

The terminal packages the feedback into a request and transmits it securely to the server over a network protocol.

The output is a feedback record received and acknowledged by the server.

### Step 18

The server stores feedback and quarantined messages as learning data.

The input is the feedback record and the current quarantine storage contents.

The server updates a training datastore with entries containing feature vectors, final classifications, user corrections, and ground-truth labels inferred from feedback.

The server marks which messages are eligible for use in future model retraining.

The output is an expanded set of learning data stored in the training datastore.

### Step 19

The server retrains or updates the statistical learning model using accumulated learning data.

The input is the training datastore containing feature vectors and labels.

The server splits the data into training and validation subsets, computes a loss function such as cross-entropy between predicted and true labels, and updates model parameters by applying an optimization algorithm.

The server evaluates the updated model on the validation subset and, if performance improves, deploys the new parameters to the statistical learning inference module.

The output is an updated statistical learning model that replaces or augments the previous model.

### Step 20

The server refines the generation rules for the prompt sentence based on past performance.

The input is historical records of prompt sentences, generative AI responses, and resulting classification accuracy.

The server analyzes correlations between prompt structures and output quality, identifies missing or redundant elements in prompt content, and adjusts the template or insertion rules.

The server stores the revised rules and applies them in subsequent prompt construction, thereby modifying structure and content of future prompt sentences. The output is an updated prompt generation configuration used in future interactions with the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern networked environments, electronic communications such as electronic mail messages, short messages, and online notifications are increasingly used as attack vectors for fraudulent activities including phishing and unsolicited communications. Conventional filtering technologies typically rely on static rule sets, simple keyword matching, and reputation lookup of identification information such as network resource locators or contact numbers. These approaches are often implemented as separate modules that do not effectively coordinate structured reputation data, statistical classification, and contextual understanding of message content. As a result, conventional systems exhibit significant limitations in both detection accuracy and explainability of their decisions.

In particular, known systems frequently suffer from high false positive rates when messages contain generic security-related terms, and high false negative rates when attackers craft messages that evade simple keyword rules while using seemingly benign identification information. Further, conventional reputation-based approaches depend heavily on the coverage and freshness of a reputation database. When the identification information is not present in the database, the system tends to default to an inconclusive or overly permissive decision, thereby exposing users to unmitigated risk.

Additionally, while statistical machine learning models have been introduced to improve classification performance, these models are typically trained on limited feature sets and produce opaque numerical scores that are difficult to interpret or reconcile with reputation-based signals. This lack of integration between reputation lookup, machine learning classification, and higher-level semantic analysis prevents the system from leveraging complementary strengths of different technologies. It also impairs the ability of the system to adapt to evolving attack patterns and to provide meaningful explanations that can be consumed by downstream applications or end users.

Moreover, emerging generative artificial intelligence models are capable of sophisticated natural language understanding and reasoning, but conventional security systems do not exploit these models in a structured and controlled manner. In many cases, such models, if used at all, are applied in an ad hoc fashion, without systematic construction of input prompts that incorporate both structured signals (such as database findings and machine learning outputs) and unstructured content (such as message body text). Without carefully designed prompt sentences and integration logic, the generative model's output may be inconsistent, difficult to aggregate with other signals, or misaligned with the operational requirements of a security system.

Accordingly, there is a need for a technical improvement to computer-based communication security systems that: (i) normalizes identification information into a standardized representation; (ii) performs structured comparison with a reputation data set; (iii) applies natural language processing to derive rich feature data from message content; (iv) uses a trained statistical estimation model for quantitative classification; (v) constructs and supplies context-aware prompt sentences to a generative artificial intelligence model; and (vi) algorithmically integrates all resulting signals into a single, reliable, and explainable risk evaluation. Such an improved architecture would enhance the overall performance of the computer system by reducing resource consumption on ineffective checks, improving classification accuracy, and generating consistent, machine-usable outputs that can be rendered efficiently on external terminals.

The specific processing by the specific processing unit 290 of the data processing device 12 in Example 2 is realized by the following means.

The present invention provides a server comprising a processor configured to normalize identification information of electronic communications into a standardized representation, compare the normalized identification information with an information set stored in an information storage to obtain a comparison result, apply a natural language processing technique to body information of the electronic communications to generate feature data, classify a risk of the electronic communications and compute a confidence value by using a trained statistical estimation model based on the feature data and the identification information, construct a prompt sentence including the body information and the identification information for input to a generative artificial intelligence model, obtain from the generative artificial intelligence model an evaluation result and a reasoning relating to the risk of the electronic communications based on the prompt sentence, integrate the comparison result, the classification result from the statistical estimation model, and the evaluation result from the generative artificial intelligence model to determine a final reliability evaluation of the electronic communications, and generate response information including warning information or guidance information based on the final reliability evaluation for output to an external terminal. This enables a computer-centered security system to combine standardized reputation analysis, statistical machine learning classification, and contextual reasoning by a generative artificial intelligence model in a coordinated processing pipeline, thereby improving detection accuracy, robustness to unknown attacks, and explainability of risk evaluations while efficiently producing structured notification data for consumption by downstream computing devices.

The term “electronic communication” refers to a digital message or data exchange transmitted over a communication network, including but not limited to electronic mail, short text messages, instant messages, and application-level notifications.

The term “body information” refers to a textual portion of an electronic communication, including sentences, phrases, and symbols that convey the main content of the communication, excluding transport headers and routing metadata.

The term “identification information” refers to data that identifies or locates a source, destination, or resource associated with an electronic communication, including but not limited to network resource locators, contact numbers, and account identifiers.

The term “normalized identification information” refers to identification information that has been converted into a standardized representation according to predefined formatting rules, such as canonicalization of character case, removal of redundant components, or conversion into an international numbering format.

The term “information set” refers to a collection of records stored in a storage medium, the records including associations between identification information and corresponding reliability or reputation attributes.

The term “information storage” refers to a hardware or software component configured to store the information set, such as a database system, a file system, or a key-value storage system.

The term “reliability” refers to a degree of trust or confidence assigned to an electronic communication or identification information, indicating whether the communication is likely to be safe, dangerous, or unknown with respect to fraudulent or malicious activity.

The term “natural language processing technique” refers to a computational method for analyzing and processing human language text, including operations such as tokenization, part-of-speech tagging, entity extraction, and key-phrase identification.

The term “feature data” refers to structured data derived from body information and identification information, representing numerical or symbolic attributes used as inputs to a statistical estimation model.

The term “statistical estimation model” refers to a trained computational model that maps feature data to predicted classes or scores by using statistical or machine learning methods, including but not limited to regression models, decision-tree models, and neural network models.

The term “classification result” refers to an output of the statistical estimation model that assigns an electronic communication to one of multiple predefined categories, such as unsafe communication, unsolicited communication, or legitimate communication.

The term “confidence value” refers to a quantitative measure indicating a likelihood or strength of belief associated with a classification result produced by the statistical estimation model.

The term “generative artificial intelligence model” refers to a machine-learned model configured to generate natural language or other structured outputs in response to textual or symbolic inputs, including models based on deep neural network architectures.

The term “prompt sentence” refers to a text sequence constructed for input to a generative artificial intelligence model, the text sequence including instructions, context, and content elements that guide the model's output.

The term “explanatory text” refers to a textual description that includes at least part of the body information and the identification information of an electronic communication, and that is used as a basis for constructing a prompt sentence.

The term “evaluation result” refers to an output from the generative artificial intelligence model indicating an assessment of the risk or safety of an electronic communication.

The term “reasoning” refers to explanatory content generated by the generative artificial intelligence model that describes factors or patterns supporting the evaluation result.

The term “final reliability evaluation” refers to a synthesized judgment regarding the safety or risk of an electronic communication, produced by integrating the comparison result, the classification result, and the evaluation result.

The term “response information” refers to data generated by the processor that represents the final reliability evaluation and that may include warning information, guidance information, or additional explanatory attributes.

The term “warning information” refers to information indicating that an electronic communication or identification information is or may be dangerous, and that advises caution or avoidance.

The term “guidance information” refers to information indicating that an electronic communication is assessed as safe or of low risk, or that provides instructions on how a user should handle the communication.

The term “notification data” refers to data formatted for transmission to and presentation on an external terminal, representing at least a part of the response information in a machine-readable form.

The term “external terminal” refers to an information processing device that is separate from the server and that is configured to transmit identification information of electronic communications to the server and to receive and display notification data from the server.

The term “unauthorized communication” refers to an electronic communication that is determined to be fraudulent or malicious, including but not limited to phishing, identity theft attempts, or similar harmful activities.

The term “unsolicited communication” refers to an electronic communication transmitted without the recipient's request or consent, including but not limited to bulk advertising messages and spam.

The term “legitimate communication” refers to an electronic communication that is determined not to be fraudulent or unsolicited, and that is consistent with expected or authorized communication patterns.

The server executes the claimed system on a computing platform comprising at least one processor, a main memory, a non-volatile storage device, and a network interface. The server operates under a general-purpose operating system such as a server-class operating system, and runs application software implemented, for example, in a high-level programming language. The server connects to one or more databases, such as a relational database management system, via a database driver. The server also communicates with one or more external generative AI model endpoints via a network using a secure protocol. The terminal operates as an external terminal device such as a smartphone, tablet, or personal computer. The terminal executes a web browser or a native application that provides a user interface for inputting identification information of electronic communications and for displaying risk evaluation results. The terminal communicates with the server over a communication network using a secure transport protocol.

The user interacts with the terminal to provide identification information of electronic communications and to receive and review the risk evaluation provided by the server. The user, for example, enters a network resource locator of a suspected message, or pastes a text of an electronic mail body into an input area presented by the terminal.

The server stores program instructions in the non-volatile storage device and loads the instructions into the main memory for execution by the processor. The server allocates data structures in the main memory to manage incoming requests, including a request context object that contains fields for identification information, normalized identification information, message body text, comparison results, feature data, classification results, generative AI model responses, and a final reliability evaluation.

The server uses specific software components to implement different functions. The server uses a URL parsing library component to decompose identification information that is a network resource locator into a scheme, host, port, path, and query. The server uses a telephone number parsing library component to standardize identification information that is a contact number into an international numbering format. The server uses a natural language processing library component, such as a tokenization and entity recognition engine, to transform message body text into a structured representation. The server uses a statistical estimation model library component, such as a model execution engine supporting logistic regression or a neural network, to produce classification outputs from numerical feature data.

The server further uses a network client library component to construct and transmit prompt sentences to a generative AI model endpoint and to receive corresponding responses.

The server normalizes identification information into a standardized representation by applying deterministic transformation rules. The server, when the identification information is a network resource locator, converts characters of the host name to lowercase, removes an explicit port number when it is equal to a default port, collapses redundant path delimiters, and discards fragments that do not affect resource access. This normalization enables the server to treat semantically identical identification strings as a single canonical form, thereby improving cache hit ratios and database index performance. The server stores the normalized identification information in a field of the request context object and uses this representation consistently for subsequent database operations and feature computations.

The server stores an information set in an information storage component such as a relational database. The server configures one or more tables in the information storage, each table including at least a key column holding normalized identification information and one or more attribute columns holding a reliability label, update timestamp, and a source indicator.

The server defines an index structure, such as a B-tree index, on the key column to accelerate lookups. The server uses a database driver to submit parameterized selection statements to the database and to receive results into in-memory record structures. By employing indexed lookups on normalized keys, the server reduces a number of I/O operations required to determine whether the identification information has an existing reputation entry.

The server retrieves body information of an electronic communication from received data supplied by the terminal or from a separate storage system identified by an identifier included in the request. The server stores the body information as a character string, encoded for example in a standard encoding, within the request context. The server cleans the body information by removing control characters and normalizing line breaks to a uniform representation to ensure consistent processing by the natural language processing library.

The server applies a natural language processing technique to the body information by invoking a tokenization function and an entity recognition function of the natural language processing library. The server obtains, for each token, a token string, a token position, and a part-of-speech tag, and obtains, for each recognized entity, an entity type and a span in the text. The server searches within the tokens and entities for patterns associated with fraudulent communications, such as tokens representing urgency terms, financial terms, authentication terms, and action verbs that are commonly used in deceptive messages. The server creates intermediate feature items, each item comprising a feature name and a numerical value, such as a count of occurrences of a given token or a binary flag indicating presence or absence of a phrase.

The server transforms the intermediate feature items into feature data in a fixed-length numerical vector format. The server, for example, maintains a predetermined feature dictionary that maps each potential feature name to a vector index. The server iterates through the feature items and writes a corresponding numerical value into the vector at the index assigned to the feature. The server normalizes numerical values using scaling rules, such as logarithmic scaling for count-based features, to reduce the influence of extreme values. The server also computes structural features based on the identification information, such as length of the host name, number of subdomains, whether the host name corresponds to a numerical network address, and similarity between the host name and a known legitimate brand name. The server stores the resulting feature data as a contiguous memory block referenced from the request context.

The server executes a statistical estimation model that has been trained in advance using labeled training data. The server, in one embodiment, uses a neural network comprising an input layer receiving the feature data, one or more hidden layers implementing non-linear activation functions, and an output layer producing a probability distribution over classes such as unsafe communication, unsolicited communication, and legitimate communication.

The server initializes model parameters by loading weight matrices and bias vectors from a model parameters file stored in the non-volatile storage device. The server performs forward propagation by multiplying the feature vector by the weight matrices, adding biases, and applying activation functions such as rectified linear units or logistic functions. The server obtains, at the output layer, numerical values representing probabilities for each class. The server determines a classification result by selecting a class with a maximum probability and computes a confidence value as the corresponding probability. T

he server trains the statistical estimation model during a training phase distinct from runtime classification. The server collects a labeled dataset of historical electronic communications, each labeled as unsafe, unsolicited, or legitimate. The server converts these historical samples into feature data using the same feature extraction pipeline that is used at runtime. The server partitions the dataset into training and validation subsets. The server iteratively updates model parameters by applying a gradient-based optimization algorithm. The server computes a loss function such as cross-entropy between predicted class probabilities and ground-truth labels, calculates gradients of the loss with respect to each parameter by back propagation, and adjusts weights and biases according to a learning rate schedule. The server optionally applies data augmentation techniques, such as slight random perturbation of token sequences or replacement of certain terms with synonyms, to increase robustness of the model to variations in wording. By storing the trained model in the non-volatile storage device and reusing the training pipeline, the server ensures that the runtime classification accurately reflects patterns learned from historical data while maintaining computational efficiency.

The server constructs a prompt sentence for a generative AI model by combining multiple components into a single text string. The server, for example, constructs the prompt sentence by concatenating an instruction segment, a context segment describing the role of the generative AI model, a body information segment including the full message text, and an identification segment indicating the normalized identification information. The server may also include a summary of internal signals, such as a statement that the information set did or did not contain the identification information, and that the statistical estimation model predicted a particular class with a specific confidence degree. By explicitly including these machine-generated signals, the server guides the generative AI model to condition its reasoning on the structured results of prior analysis.

The server dynamically adjusts the content of the prompt sentence based on intermediate results. When the information set indicates that the identification information has a known dangerous label, the server emphasizes this fact in the prompt sentence and instructs the generative AI model to confirm or elaborate on the associated risk patterns. When the statistical estimation model outputs a classification close to a decision threshold, the server includes a request in the prompt sentence for careful analysis of ambiguous or borderline cases. This non-conventional prompt design enables the server to use the generative AI model not as a monolithic classifier but as an expert module that interprets and refines prior computed signals.

The server uses a generative AI model having a specific architecture, such as a transformer-based neural network comprising multiple self-attention layers, to generate an evaluation result and a reasoning. The server transmits the prompt sentence to a generative AI model endpoint over a network connection. The server receives a response containing a natural language explanation and a summary judgment, often in a consistent format that includes phrases such as “likely phishing,” “likely spam,” or “likely legitimate,” accompanied by a rationale. The server parses the response to extract a discrete evaluation label and an explanation string, and stores these in the request context. The server may impose constraints on the generative AI model output by specifying, in the prompt sentence, that the model must produce its judgment in a structured pattern, thereby simplifying machine parsing and integration.

The server, in one concrete example, generates a prompt sentence in plain text format as follows:
“Analyze the following electronic communication and the included URL. Determine whether this communication is likely phishing, spam, or legitimate. Consider the URL reputation, text content, and typical characteristics of phishing. Provide a concise explanation and a final judgment.

### Message

Dear customer, your account will be closed today unless you confirm your password at https://example. com. Click here immediately.

URL:

https://example. com”

The server may also generate alternative prompt sentences depending on context, such as:
“Please determine whether the following URL is safe or dangerous. Consider typical phishing patterns and explain your reasoning briefly.

URL: https://example.com”

or
“Classify the following email as ‘phishing’, ‘spam’, or ‘legitimate’. Highlight any suspicious elements and provide a final judgment.

Email text:

Dear customer, your account will be closed today unless you confirm your password at https://example.com. Click here immediately.”

The server integrates the comparison result from the information set, the classification result from the statistical estimation model, and the evaluation result from the generative AI model using a rule-based or weighted aggregation scheme. The server, for example, constructs an internal scoring structure in which each subsystem contributes a numeric score and a reliability weight. The server computes an aggregate risk score as a weighted sum of individual scores and cross-checks this score with categorical outputs. When all subsystems agree on a dangerous classification, the server sets the final reliability evaluation to a highest risk category. When subsystems disagree, the server applies precedence rules, such as treating an information set entry labeled as dangerous as determinative, or downgrading an evaluation from the generative AI model if its reasoning conflicts with highly reliable database evidence. This integrated evaluation approach yields more stable and accurate risk decisions than any subsystem alone and is specifically implemented as a finite sequence of conditional operations executed by the processor.

The server generates response information based on the final reliability evaluation. The server constructs a data structure containing at least a status field indicating safe, dangerous, or unknown, a summary message field, and an optional detail field containing explanation text or numerical indicators such as the confidence value from the statistical estimation model. The server transmits the response information to the terminal in a structured format via a secure network connection. The server may apply compression or selective field transmission to reduce communication load, such as omitting detailed explanation text when the external terminal indicates limited display capability.

The terminal receives the response information and renders a corresponding visual indication. The terminal displays, for example, a red warning panel with the text “This URL is dangerous” when the final reliability evaluation indicates a dangerous communication. The terminal may also display a short textual explanation derived from the reasoning provided by the generative AI model, allowing the user to understand specific risk indicators such as urgency, password requests, or mismatched sender and brand information. The terminal, in other cases, may display a green or neutral indication when the communication is considered safe or unknown, respectively.

The server, by implementing this combination of normalization, indexed reputation lookup, structured feature extraction, trained statistical estimation, context-aware prompt construction, and multi-source integration, improves operation of the computer itself. The server reduces redundant database queries through normalization and caching of standardized identification keys. The server increases detection accuracy by combining heterogeneous signals that capture both low-level lexical patterns and high-level semantic reasoning. The server reduces false positives and false negatives by employing a trained statistical estimation model that optimizes a loss function over large datasets, and by using a generative AI model to detect previously unseen attack patterns that violate non-trivial linguistic and structural constraints encoded in the model's parameters. The server improves computational efficiency through vectorized feature representations and batched classification operations. The server reduces network traffic and processing overhead on external terminals by performing intensive analysis centrally and sending only compact, structured evaluations to the terminals.

The server processes data in ways that are not equivalent to merely automating human review of messages. The server uses numerical optimization and neural network architectures to learn complex, high-dimensional decision boundaries that human reviewers cannot consistently apply. The server applies deterministic normalization and indexing schemes that exploit hardware-efficient memory access patterns. The server designs prompt sentences that are optimized for machine understanding and integration, rather than for human readability alone. The server thus implements non-conventional processing rules and data flows that specifically exploit computing hardware capabilities to achieve improvements in speed, accuracy, and resource utilization.

The server can be realized in various embodiments. In one embodiment, the server uses a relatively shallow statistical estimation model, such as logistic regression with L2 regularization, for environments requiring strict interpretability and low latency. In another embodiment, the server uses a deeper neural network with multiple hidden layers and attention mechanisms to capture longer-range dependencies in the text. In yet another embodiment, the server uses different generative AI models depending on communication language, such as selecting a particular model instance specialized for specific language families. The server may also support multiple information storage backends, such as a relational database for long-term reputation data and an in-memory key-value store for short-term or high-frequency entries.

The terminal, in alternative embodiments, may be implemented as a browser-based client using a scripting environment, or as a native application on a mobile operating system. The terminal may cache previous results for identical identification information to reduce network requests. The user may interact with the terminal through a graphical user interface or through a voice-based interface that converts speech into text to obtain identification information.

The system, by these configurations, enables other persons skilled in the art to implement the invention on different hardware and software platforms while preserving the particular technical improvements described above.

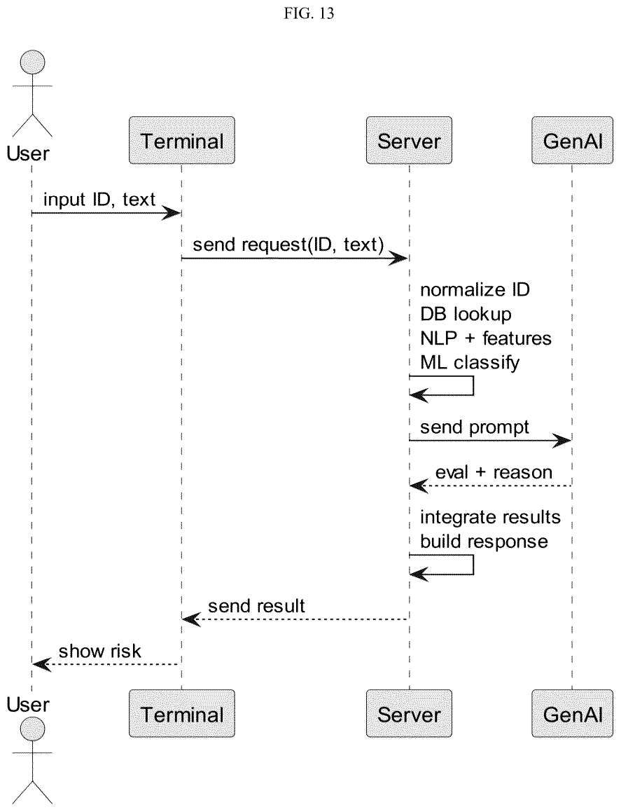

The following describes the processing flow using FIG. 13.

### Step 1

The user provides identification information and message text to the terminal.

The user enters, for example, a URL such as “https://example.com” and optionally pastes an email body into an input field displayed on the terminal.

The terminal receives the raw text input from the user interface components and packages the identification information and message text into an internal request object.

Input: User-entered identification information and message text.

Output: Internal request object on the terminal containing raw identification information and raw message text.

### Step 2

The terminal transmits the internal request object to the server.

The terminal serializes the internal request object into a network message, includes fields such as identification type and identification value, and sends the message to the server using a secure communication protocol.

The terminal waits for an acknowledgment or response from the server after sending the network message.

Input: Internal request object on the terminal.

Output: Network request containing identification information and message text, delivered to the server.

### Step 3

The server receives and parses the network request.

The server accepts the incoming connection via a network interface, reads the request payload, and decodes the payload into a server-side request context object.

The server validates the presence and basic format of required fields such as identification type and identification value and rejects the request if essential fields are missing.

Input: Network request containing serialized identification information and message text.

Output: Server-side request context object containing raw identification information and raw message text.

### Step 4

The server normalizes the identification information.

The server determines whether the identification information is a URL or a contact number based on the identification type field.

The server, when the identification information is a URL, parses the URL into components, converts the host name to lowercase, removes default ports, normalizes the path, and reconstructs a canonical URL string.

The server, when the identification information is a contact number, applies a telephone number parsing library to convert the number into a standardized international format.

The server stores the normalized identification information back into the request context object.

Input: Raw identification information in the request context object.

Output: Normalized identification information stored in the request context object.

### Step 5

The server performs a reputation lookup in the information storage.

The server uses the normalized identification information as a key to query an information set stored in a database, sending a parameterized query through a database driver.

The server retrieves a record indicating whether the identification information is associated with a dangerous, safe, or unknown status, or receives an empty result when no record exists.

The server records the comparison result and associated attributes, such as a reliability label

and timestamp, in the request context object. Input: Normalized identification information.

Output: Comparison result from the information set, including a reliability label or an indication of no record, stored in the request context object.

### Step 6

The server prepares the body information for natural language processing.

The server retrieves the raw message text from the request context object and verifies that the text is encoded in a supported character encoding.

The server removes control characters, normalizes whitespace, and standardizes line breaks to ensure consistent tokenization.

The server stores the cleaned message text as processed body information in the request context object.

Input: Raw message text in the request context object.

Output: Cleaned and standardized body information ready for natural language processing.

### Step 7

The server applies a natural language processing technique to the body information.

The server uses a tokenization function to split the body information into tokens and applies part-of-speech tagging and entity recognition functions to annotate the tokens.

The server identifies tokens and entities that correspond to urgency expressions, financial terms, authentication-related phrases, and action prompts that are characteristic of phishing or spam.

The server generates intermediate feature items, each indicating a detected term or pattern and its frequency or presence, and stores them in the request context object.

Input: Cleaned body information.

Output: Intermediate feature items representing linguistic patterns and entities in the body information.

### Step 8

The server constructs numerical feature data from the intermediate feature items and structural attributes.

The server maps each feature item to a predefined index in a feature dictionary and initializes a feature vector with default values.

The server writes counts, flags, or scores into the corresponding positions in the feature vector and applies normalization rules such as scaling counts.

The server also computes structural features from the normalized identification information, such as length and subdomain count, and inserts these numeric values into designated positions of the feature vector.

The server stores the completed feature vector in the request context object.

Input: Intermediate feature items and normalized identification information. Output: Numerical feature vector stored in the request context object.

### Step 9

The server executes the statistical estimation model to classify the electronic communication.

The server loads or accesses a trained model, applies the model to the feature vector, and computes output activations representing class probabilities.

The server selects a class label corresponding to the maximum probability and records this label as the classification result, while also storing the associated probability as the confidence value.

The server writes the classification result and confidence value into the request context object.

Input: Numerical feature vector.

Output: Classification result (such as unsafe, unsolicited, or legitimate) and confidence value

stored in the request context object.

### Step 10

The server constructs a prompt sentence for a generative AI model.

The server retrieves the cleaned body information, normalized identification information, comparison result from the information set, and classification result from the statistical estimation model from the request context object.

The server combines these elements into a single text sequence that includes instructions, context, the full message text, and the identification information, and optionally includes a description of current internal findings.

The server adjusts the wording of the prompt sentence, for example emphasizing known dangerous reputation or borderline classification, to guide the generative AI model towards focused analysis.

Input: Cleaned body information, normalized identification information, comparison result, and classification result.

Output: Prompt sentence text string stored in the request context object.

### Step 11

The server sends the prompt sentence to a generative AI model and receives an evaluation result.

The server transmits the prompt sentence to a generative AI model endpoint using a network client, specifying model parameters such as maximum response length.

The server receives a textual response from the generative AI model that includes a risk assessment label and a natural language explanation describing reasons for the assessment.

The server parses the response to extract a discrete evaluation label and reasoning text and records them in the request context object.

Input: Prompt sentence text string.

Output: Evaluation label and reasoning text from the generative AI model stored in the request context object.

### Step 12

The server integrates the comparison result, classification result, and evaluation result into a final reliability evaluation.

The server reads the reliability label from the information set, the statistical classification and confidence value, and the generative AI evaluation label from the request context object.

The server applies an aggregation algorithm that assigns weights or precedence to each source, computes a combined risk score, and determines a final categorical evaluation such as dangerous, safe, or unknown.

The server stores the final reliability evaluation and may link it with a concise explanation derived from the reasoning text. Input: Comparison result from the information set, classification result and confidence value,

and generative AI evaluation label and reasoning.

Output: Final reliability evaluation and associated explanation stored in the request context object.

### Step 13

The server generates response information for the terminal.

The server creates a response structure containing at least the final reliability evaluation, a summary message such as “This URL is dangerous,” and optional detail fields including confidence values and explanation text.

The server serializes the response structure into a network message and sends it to the terminal using a secure protocol.

Input: Final reliability evaluation and associated explanation.

Output: Network response containing structured response information delivered to the terminal.

### Step 14

The terminal receives the response information and presents results to the user.

The terminal decodes the network response, extracts the final reliability evaluation and summary message, and updates its user interface accordingly. The terminal, for example, displays a colored banner and explanatory text indicating whether the communication is dangerous, safe, or unknown, and may prevent automatic opening of dangerous links based on the evaluation.

Input: Network response containing structured response information.

Output: Visual or other perceptible indication of the risk evaluation presented to the user on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional electronic message security systems typically rely on a narrow subset of technical signals, such as static blacklists of domains, simple keyword filters, or single machine-learning classifiers that operate only on message text. These systems are often implemented as monolithic components that assign a risk score based on limited content features and do not flexibly incorporate heterogeneous data sources, such as identifier reputation, linguistic naturalness, contextual metadata, and real-time user state. As a result, these systems suffer from reduced detection accuracy, high false-positive and false-negative rates, and poor adaptability to evolving attack patterns such as sophisticated phishing messages and socially engineered communications.

In addition, many existing systems are not architected to utilize modern generative AI models in a controlled, structured way. When generative models are used, they are often invoked ad hoc, without a well-defined prompt structure or integration pipeline, which makes their output difficult to combine with other analytic components and leads to unpredictable behavior. Consequently, computing resources are not efficiently used, inference latency increases, and the overall reliability and reproducibility of the security assessment are degraded.

Furthermore, conventional message analysis engines usually ignore user-side contextual signals such as the user's emotional reaction while reading a message. From a computer-system perspective, the terminal hardware (sensors) and server-side processors are not systematically coupled to collect, normalize, and exploit emotion-related data as part of the scoring pipeline. The absence of such integration means that the system cannot dynamically adjust risk evaluation based on how the message is perceived, which limits personalization and can cause either over-aggressive blocking or insufficient warning for certain users.

There is therefore a need for an improved computer-implemented system and processing architecture that (i) structurally integrates multiple analytic subsystems, including identifier reputation checks, linguistic and metadata analysis, emotion recognition, and generative AI evaluation, (ii) coordinates these subsystems through explicit prompt sentences and standardized indices, and (iii) programmatically fuses the outputs into a final danger level and explanatory information. Such a system should enhance the technical performance of message-risk evaluation, including accuracy, robustness to new attack patterns, computational efficiency, and the quality and usefulness of warnings presented to the user.

The specific processing by the specific processing unit 290 of the data processing device 12 in Application Example 2 is realized by the following means.

The present invention provides a server comprising a processor configured to generate a structured prompt sentence for a generative AI model based on a body of an electronic message, identification information extracted from the body, and intermediate analysis results of the body; to compare the extracted identification information with a reference information set stored in a storage apparatus and calculate, based on a comparison result, at least one of a reliability index of the identification information and a danger index of the electronic message; to analyze the message body by using at least one of a natural language processing technique and a machine-learning technique to detect grammatical errors, unnatural expressions, and high-risk phrases and calculate, based on a detection result, a content-based danger index; to analyze attribute information including at least one of a source address, a transmission time, and a network parameter relating to the electronic message and calculate, based on the attribute information, a trust index; to analyze emotion-related information including at least one of facial information and voice information of a user by using an emotion recognition technique, recognize an emotion of the user, and adjust the danger index of the electronic message by increasing the danger index when a negative emotion is detected and decreasing the danger index when a positive emotion is detected; to integrate at least part of the reliability index, the content-based danger index, the trust index, an emotion-adjusted danger index, and an evaluation result received from the generative AI model in response to the prompt sentence, and determine, based on an integration result, a final danger level of the electronic message and explanatory information corresponding to the final danger level; and to generate warning information in accordance with the final danger level and the explanatory information and transmit the warning information to a terminal device for notification to the user. This enables the computing system to technically improve electronic message risk evaluation by orchestrating heterogeneous analytic components through explicit prompt sentences and normalized indices, by programmatically fusing database reputation data, linguistic and metadata analysis, emotion-derived adjustments, and generative model outputs into a unified danger score, and by efficiently producing structured warnings with explanatory content, thereby reducing misclassification rates, enhancing robustness to novel attack patterns, and improving the overall security functionality and responsiveness of the server-terminal architecture.

The term “system” refers to an arrangement of one or more computing devices, including at least a server-side device comprising a processor and optionally one or more terminal devices, that cooperate to perform electronic message risk evaluation and notification processing.

The term “processor” refers to one or more hardware processing units, such as a central processing unit, a graphics processing unit, or a dedicated accelerator, configured by executable instructions to perform operations including data acquisition, analysis, integration, and control of message-related processes.

The term “electronic message” refers to digital communication data transmitted over a network, including but not limited to electronic mail, instant messages, or other text-based communications having a message body and associated metadata.

The term “message body” refers to a content portion of an electronic message, including textual data and optionally embedded identifiers, that is subject to analysis by the processor.

The term “identification information” refers to data elements included in an electronic message that can be used to identify a source, destination, or resource, such as a network address, a contact address, or a resource locator.

The term “reference information set” refers to a structured collection of data stored in a storage apparatus and used as a basis for comparison with identification information, including entries indicating trustworthy or malicious entities, resources, or communication patterns.

The term “storage apparatus” refers to any hardware device or combination of devices configured to store digital data, such as a volatile memory, a non-volatile memory, or a mass storage device, accessible by the processor.

The term “reliability index” refers to a computed numerical or categorical value representing a degree of trustworthiness of identification information or an electronic message relative to the reference information set.

The term “danger index” refers to a computed numerical or categorical value representing a degree of potential risk or harm associated with an electronic message based on one or more analytic results.

The term “content-based danger index” refers to a danger index that is computed from analysis of the message body, including linguistic features, grammatical correctness, and presence of risky expressions, independent of metadata and emotion-related information.

The term “trust index” refers to a numerical or categorical value representing a degree of trust assigned to an electronic message based on analysis of attribute information such as source identifiers, timing, or network parameters.

The term “attribute information” refers to metadata associated with an electronic message, including but not limited to a source address, a destination address, a transmission time, a protocol parameter, or other contextual transmission data.

The term “network parameter” refers to information related to communication over a network, such as an internet protocol address, a port number, a domain name, a routing parameter, or a protocol identifier.

The term “natural language processing technique” refers to a computational procedure that analyzes human language data, such as tokenization, part-of-speech tagging, syntactic parsing, semantic analysis, or named-entity recognition, to derive structured representations or features.

The term “machine-learning technique” refers to a computational procedure that uses a statistical or algorithmic model trained on data to generate predictions, classifications, or scores for new data without being explicitly programmed for each specific input pattern.

The term “grammatical error” refers to a deviation from syntactic or morphological rules of a natural language detected in the message body by a natural language processing technique or a machine-learning technique.

The term “unnatural expression” refers to a linguistic pattern in the message body that is atypical or inconsistent with normal language usage, as determined by a language model, rule set, or statistical analysis.

The term “high-risk phrase” refers to a sequence of one or more words in the message body that is empirically associated with fraudulent, malicious, or otherwise harmful communications, such as phrases urging urgent financial action or credential disclosure.

The term “emotion-related information” refers to data obtained from sensing or measuring user behavior or state, including at least facial information or voice information, which can be analyzed to infer an emotional condition of the user.

The term “facial information” refers to image or video data representing at least part of a user's face, including spatial configurations or temporal changes of facial features, that can be used to infer emotional expressions.

The term “voice information” refers to audio data representing speech or other vocal sounds produced by a user, including acoustic characteristics such as pitch, energy, and prosody, that can be used to infer emotional states.

The term “emotion recognition technique” refers to a computational procedure that processes emotion-related information, such as facial information or voice information, to estimate one or more emotional categories and corresponding intensities associated with a user.

The term “negative emotion” refers to an emotional category indicating an adverse or risk-associated state of a user, such as fear, anger, anxiety, or confusion, as determined by an emotion recognition technique.

The term “positive emotion” refers to an emotional category indicating a favorable or low-risk state of a user, such as joy, satisfaction, or calmness, as determined by an emotion recognition technique.

The term “emotion-adjusted danger index” refers to a danger index that has been increased or decreased based on an emotion recognition result, such that stronger negative emotions raise the index and stronger positive emotions lower the index according to predefined rules or models.

The term “generative AI model” refers to a computational model that, in response to an input prompt sentence, produces natural-language output or other structured content by probabilistically generating sequences based on learned patterns.

The term “prompt sentence” refers to a machine-interpretable natural-language instruction or query generated by the processor and provided to a generative AI model to control a type, scope, or focus of an evaluation or explanation to be performed by the generative AI model.

The term “evaluation result” refers to information output by the generative AI model, in response to the prompt sentence, indicating at least an assessment of a danger level, an assessment of safety of identification information, or an explanation of recommended user behavior.

The term “final danger level” refers to a consolidated representation of risk associated with an electronic message, computed by integrating multiple indices and evaluation results into a single risk classification or score.

The term “explanatory information” refers to data describing reasons or factors underlying the final danger level, including references to specific identifiers, linguistic features, metadata, or emotion-related conditions that contributed to the risk assessment.

The term “warning information” refers to data generated by the processor and intended for presentation to a user, including at least the final danger level and explanatory information, and optionally guidance for handling the electronic message.

The term “terminal device” refers to a user-operated computing device, such as a mobile device, a desktop device, or a wearable device, configured to display the warning information, present the notification to the user, and optionally capture emotion-related information.

In one embodiment, a server executes a message-analysis program on a hardware platform comprising at least one central processing unit, a main memory, a non-volatile storage device, and a network interface. The server runs a general-purpose operating system and a middleware stack that may include a web application framework, a database management system, and numerical computation libraries. The server cooperates with one or more terminals, each terminal including at least one processor, a memory, a display device, a camera, a microphone, and a network interface. The server stores executable instructions in the non-volatile storage device, and the processor of the server loads these instructions into the main memory and executes them to perform the functions described below.

The server implements a modular software architecture including a message ingestion module, an identifier extraction module, a reference-set matching module, a linguistic analysis module, a machine-learning scoring module, an attribute analysis module, an emotion integration module, a generative AI interface module, a risk fusion module, and a notification generation module. Each module exchanges data through defined data structures stored in a relational database system, such as tables for messages, identifiers, risk indices, emotion records, and AI evaluation results.

The server uses a natural language processing library, such as a tokenization and parsing toolkit, to process message bodies. The server uses a pattern matching library based on regular expressions to detect identification information such as network resource locators, contact addresses, and numerical identifiers. The server uses a machine-learning library such as a numerical computation framework to train and execute supervised classification models.

The server uses a database engine implementing a structured query language to maintain a reference information set containing trusted and malicious entities. The server may use an external generative AI service accessed via an application programming interface, where the underlying model may be a transformer-based neural network trained on large text corpora.

The server stores electronic messages in a message table, where each row contains fields such as a message identifier, a sender address, a recipient address, a timestamp, a network parameter, and a message body. The server stores extracted identification information in an identifier table linked to the message table via the message identifier. The server attaches fields to each identifier record indicating a type (for example, network resource locator, contact address, numerical identifier), a parsed domain or prefix, and a raw text span from the message body.

The server accesses a reference information set stored in additional tables, including a trusted entity table and a malicious entity table. The server inserts each parsed domain or other identifier key into query statements executed against these tables. The server calculates a reliability index for each identifier by mapping the query result to a numeric scale, for example, assigning a high reliability value to known trusted entries, a low reliability value to known malicious entries, and an intermediate value to unknown entries. The server then aggregates identifier-level indices into a message-level reliability index using a deterministic rule, such as computing a maximum of malicious scores and a weighted sum of trusted scores.

The server executes a linguistic analysis module using a natural language processing toolkit. The server tokenizes the message body into words and sentences. The server performs part-of-speech tagging and dependency parsing. The server compares parsed structures against a learned or rule-based language model to detect grammatical errors and unnatural expressions. For example, the server may represent each sentence as a vector of syntactic features, including counts of specific dependency patterns, part-of-speech bigrams, and sentence length statistics. The server applies thresholds or classifier outputs to determine whether the sentence exhibits atypical or suspicious structure. The server also matches the message body against a dictionary of high-risk phrases, such as phrases requesting financial transfer or credential disclosure, by scanning for specific n-gram sequences.

The server computes a content-based danger index by combining syntactic anomaly scores, semantic anomaly scores, and frequencies of high-risk phrases. In one embodiment, the server uses a logistic regression model or a small feed-forward neural network that takes as input a feature vector including counts of high-risk tokens, a grammatical error count, an unnatural expression score, total message length, and ratio of imperative sentences. The server stores the resulting content-based danger index in a risk index table.

The server also evaluates attribute information such as source addresses, network parameters, and timestamps. The server queries a table containing known network ranges, domain patterns, and expected communication windows. The server computes a trust index based on whether the source address belongs to an expected range, whether the domain matches a pattern of legitimate entities, and whether the transmission time is within normal business hours for the relevant domain. The server implements a scoring function that penalizes mismatched domains or unusual transmission times and stores the trust index in the risk index table.

The server implements a machine-learning scoring module using a supervised learning model trained on a corpus of labeled messages. In one example, the server trains a gradient-boosted decision tree classifier. In another example, the server trains a neural network comprising an embedding layer for tokens, a recurrent or transformer encoder, and a final dense layer that outputs a phishing probability. During training, the server feeds labeled message texts to the model, computes a cross-entropy loss between predicted and actual labels, and updates model weights using stochastic gradient descent or a variant thereof. The server may apply data augmentation techniques such as synonym substitution, random deletion of low-importance tokens, or small perturbations in word order to increase robustness. The server stores trained model parameters in the storage device and loads them into memory at runtime.

The server converts each new message into model input by constructing a feature vector or token sequence. When using a feature-based model, the server applies a term frequency-inverse document frequency transformation and concatenates domain-specific features, such as presence of “urgent” or “verify account” phrases. When using a neural network model, the server tokenizes the message into tokens, maps tokens to embeddings using a learned embedding matrix, and passes the sequence through the encoder. The server receives a numeric output representing a phishing probability or multi-class probabilities. The server converts this output into an ML-based risk index and stores it with the message record.

The server interacts with a generative AI model through a generative AI interface module.

The server uses analysis results from the identifier extraction module, linguistic analysis module, and machine-learning module to construct a structured prompt sentence. The server concatenates a description of the message body, a list of extracted identification information, and summary indicators such as “blacklisted domain detected” or “high grammatical anomaly score.” The server then formats a textual instruction such as:
“You are a security analysis generative AI model. Analyze the following email and determine whether it is likely phishing or fraudulent. Consider the URLs, wording, urgency, and any indications of known malicious domains. Email text: ‘Dear user, your account will be closed today unless you verify it immediately at http://example-phishing-domain.test.’ Return a danger level (Low, Medium, High) and a brief explanation.”

The server transmits this prompt sentence via a network interface to a remote generative AI engine. The generative AI engine, which may internally use a transformer-based architecture with multiple self-attention layers and feed-forward layers, generates a natural-language response. The server receives the response, parses a stated danger level and an explanation, and maps the danger level to a numeric AI-based risk index.

The server integrates multiple indices in a risk fusion module. The server accesses the reliability index, content-based danger index, trust index, ML-based risk index, and AI-based risk index, along with an emotion-adjusted index described below. The server applies a fusion algorithm such as a weighted sum followed by a nonlinear transformation. The server can implement the fusion as a second-stage model, for example a small neural network that takes as inputs the normalized indices and outputs a final danger level. The server trains this second-stage model on historical data including ground-truth labels of whether messages were malicious and how users responded. The server uses a loss function such as weighted cross-entropy that penalizes false negatives more heavily than false positives, thereby technically improving risk classification in a safety-critical context.

The terminal executes an emotion capture program when a user views a message. The terminal uses the camera to capture video frames of the user's face and uses the microphone to capture voice signals if the user speaks or emits sounds. The terminal pre-processes raw sensor data using a computer vision library and an audio analysis library. The terminal extracts facial features, such as positions of eyes, mouth, and eyebrows, and generates a set of geometric or appearance-based descriptors. The terminal extracts audio features such as short-time energy, fundamental frequency, and spectral characteristics. The terminal applies an emotion recognition model to these features. In one embodiment, the terminal uses a convolutional neural network to process frames of facial images. The convolutional network includes successive convolution and pooling layers, a flattening layer, and fully connected layers that output probabilities across emotion categories such as fear, anger, joy, and neutral. The terminal trains this model offline on a labeled dataset of facial expressions, minimizing a categorical cross-entropy loss using stochastic gradient descent. In another embodiment, the terminal uses a recurrent network or temporal convolution network to account for changes in expressions over time.

The terminal encodes the recognized emotion as an emotion record containing fields such as user identifier, message identifier, dominant emotion label, intensity, and timestamp. The terminal transmits this emotion record to the server via the network interface. The server receives the emotion record and updates an emotion table.

The server uses the emotion integration module to adjust the raw danger index. The server defines a mapping function such that strong negative emotions, such as fear with high intensity, increase the danger index by a multiplicative or additive factor, while strong positive emotions decrease the index slightly. The server implements this mapping as a parameterized function that is tuned using validation data, so that the adjustment improves predictive performance without over-amplifying noise. The server thus constructs an emotion-adjusted danger index that is input to the risk fusion module. This non-conventional combination of system-observed risk features and user-state features enables the system to resolve cases where message content appears borderline but user reaction indicates confusion or anxiety, thereby decreasing missed detections of socially engineered attacks.

The server then generates warning information comprising the final danger level and explanatory information. The server formats the warning as a structured record that includes a human-readable explanation, such as “Blacklisted domain detected, urgent account closure wording, high grammatical anomaly, and user fear reaction observed. High risk of phishing.”

The server also includes machine-interpretable flags indicating specific identifiers to highlight and recommended actions such as “do not click links” or “verify via separate channel.” The server transmits this warning information to the terminal. The terminal receives the warning record and uses its display hardware and operating system notification mechanisms to present the warning to the user. The terminal may visually highlight dangerous identifiers in the message view, apply color coding, and display an overlay indicating the danger level. The terminal may emit an audible alert or vibration. By controlling specific hardware outputs based on computed indices, the system ties the abstract analysis to concrete device behavior, satisfying a technical usage requirement.

The user views the warning and decides whether to delete the message, report it as malicious, or ignore it. The terminal may send optional feedback to the server indicating the user's action. The server records this feedback and uses it in subsequent training cycles to refine the machine-learning models, thereby improving classification accuracy over time.

The server improves computer technology in several ways. First, the server reduces processing load and network bandwidth by selectively invoking the generative AI model only when intermediate indices indicate ambiguity or medium risk, as opposed to all messages.

The server determines a threshold region for which generative AI evaluation is cost-effective, which reduces unnecessary remote calls and latency. Second, the server improves accuracy by integrating heterogeneous signals identifier reputation, structural language anomalies, metadata, machine-learning scores, and emotion-based adjustments using a defined data structure and fusion algorithm, rather than relying on a single heuristic filter. Third, the server improves robustness and generalization to new attack patterns through training procedures that incorporate data augmentation and multi-stage modeling, which are not part of traditional rule-based spam filters.

The server uses non-conventional processing rules compared to human review. For example, the server computes a syntactic anomaly score by comparing dependency pattern frequencies against a baseline distribution learned from benign messages; this is not simply reproducing human judgment, but exploiting high-dimensional statistical structures discovered during training. The server also uses a rule that a strong negative emotion combined with a moderate content-based score triggers an elevated warning, even if classical filters might mark the message as safe. This rule exploits machine-observable correlations between user state and subtle message features, which are difficult for human operators to track consistently.

In alternative embodiments, the server may use different model architectures for the generative AI model, such as a smaller domain-specific language model fine-tuned on security-related text, or may perform on-premise inference instead of remote calls. The server may represent reference information sets as graph structures in a graph database and perform graph-based anomaly detection on relationships between identifiers. The server may adopt alternate emotion recognition pipelines, such as using only audio features in voice-only environments. The terminal may run a lightweight subset of modules when local computational resources are constrained, performing only feature extraction and delegating heavier analysis to the server.

In another variation, the server may maintain separate models and thresholds for different categories of users or organizations, storing configuration profiles in the database. The server can then tailor fusion weights or emotion-based adjustments per profile, achieving further technical optimization of false-positive and false-negative trade-offs for heterogeneous environments.

By defining specific data structures, models, and integration algorithms operating across server and terminal, and by specifying how indices and prompt sentences are constructed and consumed, the system goes beyond a generic automation of human review. The server implements a particular improved architecture for electronic message risk evaluation that exploits modern generative AI models, multi-modal signals, and non-conventional fusion logic to achieve measurable improvements in classification accuracy, computational efficiency, and real-time responsiveness in a networked communication environment.

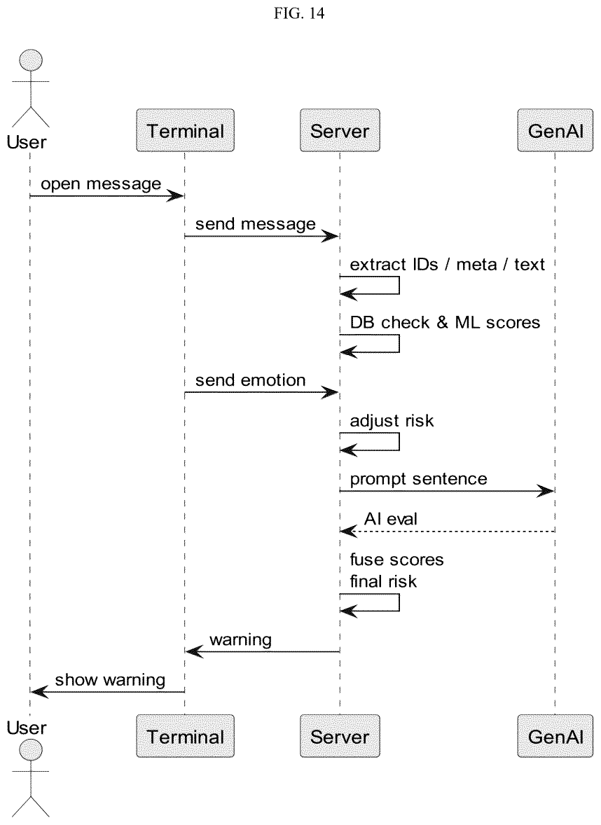

The following describes the processing flow using FIG. 14.

### Step 1

Server receives an electronic message from the terminal and stores it.

Server takes as input a message object including at least a message body, a sender address, a recipient address, a transmission timestamp, and one or more network parameters. Server parses the received data packet, validates a format of header fields, and writes the message into a message table of a database, assigning a unique message identifier as output. Server thereby converts raw network packets into a structured record that can be referenced by subsequent modules.

### Step 2

Server extracts identification information from the message body.

Server takes as input the stored message body associated with the message identifier. Server applies regular expression patterns to the text to detect sequences matching network resource locators, contact addresses, and numerical identifiers, and server uses a natural language processing library to perform additional named-entity recognition. Server outputs an identifier list in which each element includes a type field, a value field, and a character offset range in the message body, and stores this list in an identifier table linked to the message identifier. Server thus transforms unstructured textual content into a normalized set of identification information.

### Step 3

Server compares identification information with a reference information set and computes a reliability index.

Server takes as input the identifier list for the message and a reference information set stored in a database, including trusted and malicious entity tables. Server derives a lookup key from each identifier value, for example a domain portion of a network resource locator or a normalized contact address, and issues structured queries to the reference information set.

Server then assigns a reliability score to each identifier according to whether the key is found in a trusted table, a malicious table, or neither. Server outputs identifier-level reliability records and a message-level reliability index, for example by aggregating identifier scores using a maximum or weighted sum, and writes these indices into a risk index table.

### Step 4

Server performs linguistic analysis of the message body and calculates a content-based danger index.

Server takes as input the message body and a set of linguistic models or rule sets. Server tokenizes the text into sentences and tokens, applies part-of-speech tagging, and constructs dependency parse trees. Server calculates a grammatical error count by comparing observed syntactic patterns against a baseline model of correct language use, and server computes an unnatural expression score by evaluating the probability of token sequences under a language model. Server additionally scans the message for high-risk phrases by matching n-gram sequences against a predefined list of risky patterns such as urgent financial requests. Server combines these metrics into a feature vector and applies a scoring function, such as a linear or logistic combination, to output a content-based danger index, which server stores in association with the message identifier.

### Step 5

Server evaluates the message using a machine-learning model and produces an ML-based risk index.

Server takes as input the message body and a trained classification model (for example, a gradient-boosted tree model or a neural network). Server converts the message body into model input by either computing a term frequency-inverse document frequency vector combined with custom features or by tokenizing and embedding the text into a sequence of numeric vectors. Server feeds this representation into the model, which executes numerical operations such as matrix multiplications, non-linear activations, and tree traversals to generate a probability that the message belongs to a malicious class. Server maps this probability to an ML-based risk index and outputs this index to the risk index table.

### Step 6

Server analyzes attribute information and computes a trust index.

Server takes as input metadata associated with the message, including at least a source address, a sender domain, a transmission time, and a network parameter such as an IP address. Server queries tables storing expected address ranges, known domain patterns, and typical communication windows, and performs comparisons between message attributes and stored patterns. Server calculates one or more sub-scores, for example a domain similarity score, an IP range validity score, and a time-of-day conformity score, and then combines these sub-scores, for example using a weighted sum, into a single trust index. Server outputs the trust index and stores it as an additional risk-related record.

### Step 7

Terminal captures emotion-related information from the user and sends it to the server.

Terminal takes as input sensor data, including video from a camera and audio from a microphone, while the user views the message. Terminal applies computer vision operations to detect a face region, normalizes the facial image, and extracts facial feature descriptors. Terminal applies audio processing operations to compute features such as fundamental frequency, spectral energy distribution, and prosodic contours. Terminal feeds these features into an emotion recognition model executing on the terminal processor, which outputs emotion categories and intensities. Terminal then packages a user identifier, the message identifier, the dominant emotion label, and an intensity value into an emotion record as output and transmits this record to the server.

### Step 8

Server adjusts a danger index based on emotion-related information.

Server takes as input the emotion record from the terminal and a preliminary danger index for the message obtained from earlier steps. Server interprets the emotion label and intensity, for example mapping negative categories such as fear or anger to a positive adjustment factor and positive categories such as joy or calmness to a negative adjustment factor. Server applies a predefined mapping function, such as multiplying the preliminary index by (1+α) for strong negative emotions or by (1−β) for strong positive emotions, where α and β are stored parameters. Server outputs an emotion-adjusted danger index and updates the risk index table so that subsequent processing uses the adjusted value.

### Step 9

Server generates a prompt sentence for a generative AI model based on aggregated analysis results.

Server takes as input the message body, the identifier list, and intermediate indices including the reliability index, the content-based danger index, the trust index, the ML-based risk index, and optionally the emotion-adjusted index. Server constructs a structured textual instruction by concatenating a description of the message content, a list of extracted identification information, and summary statements of the indices. Server formats this into a prompt sentence such as:
“You are a security analysis generative AI model. Analyze the following email and determine whether it is likely phishing or fraudulent. Consider the URLs, wording, urgency, and any indications of known malicious domains. Email text: ‘[message body]’. Return a danger level (Low, Medium, High) and a brief explanation.”

Server outputs this prompt sentence and sends it to the generative AI model via an application programming interface.

### Step 10

Server receives an evaluation result from the generative AI model and converts it into an AI-based risk index.

Server takes as input a natural-language response from the generative AI model produced in response to the prompt sentence. Server applies text parsing operations to extract a declared danger level and any structured explanation phrases. Server maps the danger level (for example, text “High,” “Medium,” or “Low”) to a numeric AI-based risk index using a predetermined mapping table. Server outputs the AI-based risk index and explanatory text and stores them in association with the message identifier.

### Step 11

Server integrates multiple indices and determines a final danger level and explanatory information.

Server takes as input all available indices for the message, including the reliability index, the content-based danger index, the trust index, the ML-based risk index, the emotion-adjusted index, and the AI-based risk index. Server normalizes each index onto a common numeric scale and feeds the resulting vector into a fusion algorithm, which may be implemented as a deterministic weighted sum or as a second-stage machine-learning model. Server computes a combined score and then applies thresholding rules or model outputs to convert the combined score into a final danger level category. Server also composes explanatory information by selecting and combining textual fragments that correspond to the largest contributing indices, such as mentioning a blacklisted domain or a high grammatical anomaly score. Server outputs the final danger level and the explanatory information.

### Step 12

Server generates warning information and sends it to the terminal. Server takes as input the final danger level and the explanatory information for the message. Server constructs warning information that includes a human-readable warning sentence, a representation of the final danger level, and flags identifying specific risky identifiers. Server may tailor the wording based on the severity, for example generating text such as “This email is highly dangerous. Do not click any links or provide credentials.” Server outputs a warning record and transmits it to the terminal through a network interface.

### Step 13

Terminal presents warning information to the user using local hardware resources. Terminal takes as input the warning record received from the server and the associated message context. Terminal invokes operating system APIs to display a visual notification, renders the warning text on the display near the message body, and highlights dangerous identifiers with distinctive colors or icons. Terminal may also drive an audio output device or a haptic actuator to emit an alert. Terminal outputs a graphical and auditory presentation that informs the user of the assessed risk before any interaction with suspicious elements.

### Step 14

User reacts to the warning and optionally provides feedback.

User takes as input the displayed warning information and the visualized message content.

User performs a selection operation, such as deleting the message, moving it to a spam folder, or ignoring the warning and opening a link. User's action may be captured by the terminal as feedback. Terminal sends a feedback record including the message identifier and the user's action to the server as output, and server can store this record for later analysis, model retraining, or adjustment of parameters.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

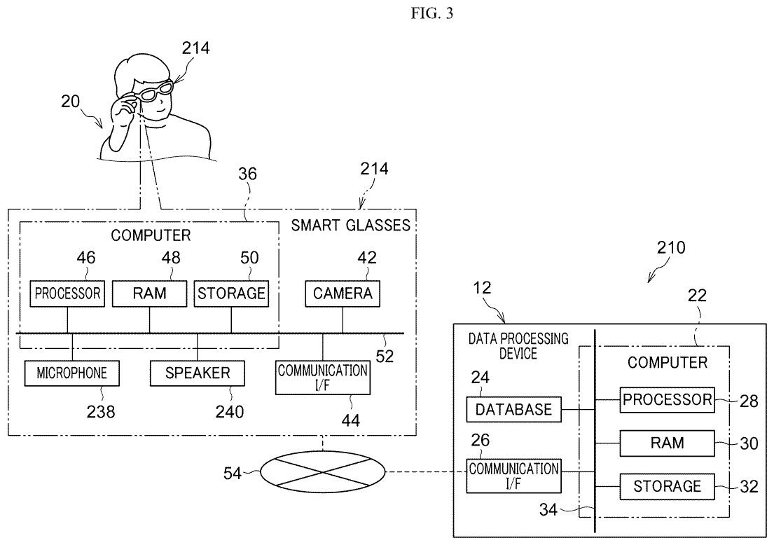

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

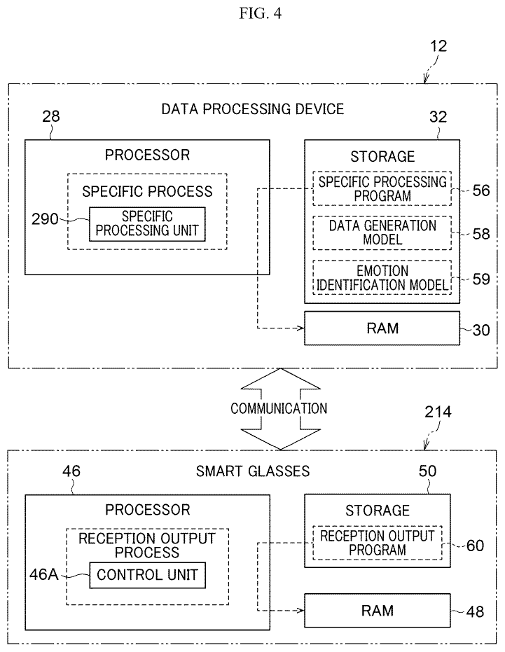

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

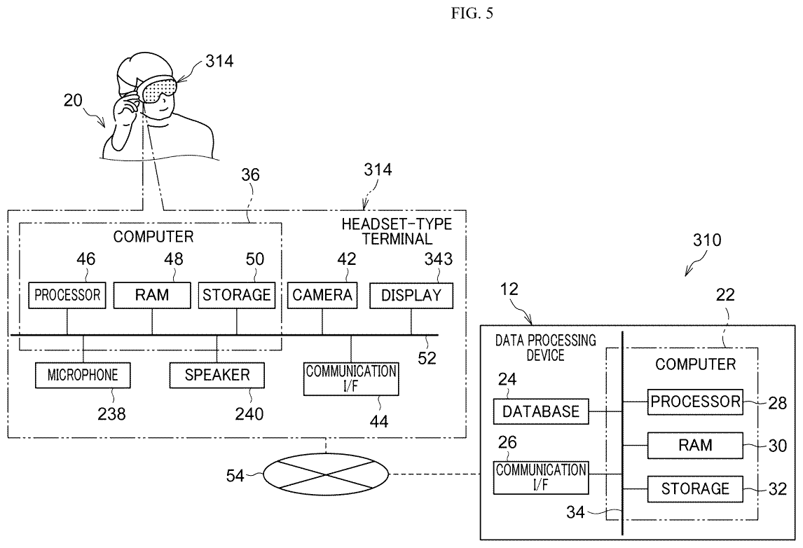

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

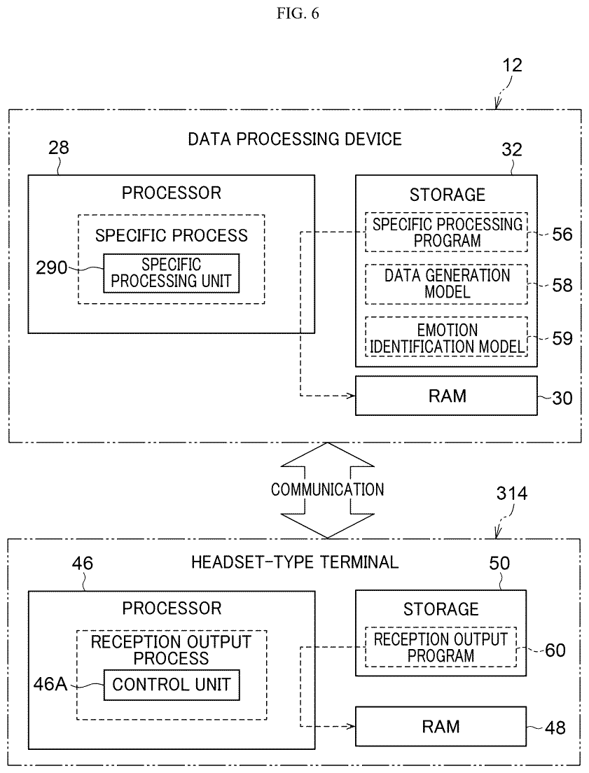

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

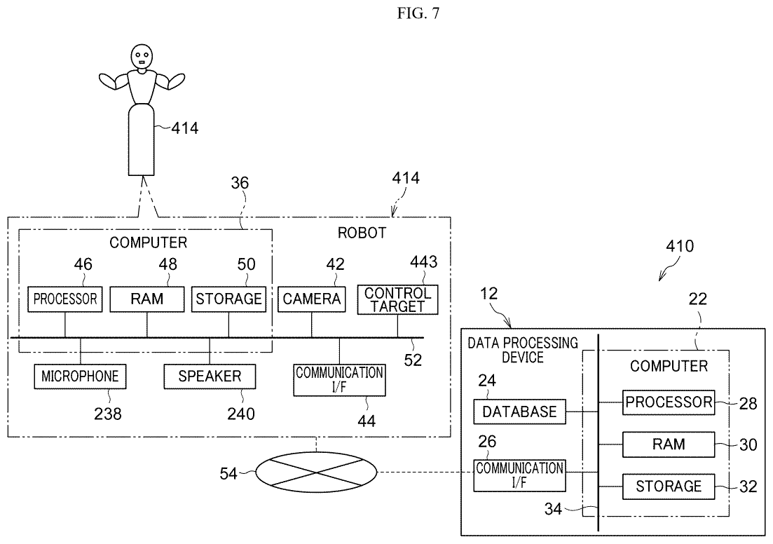

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

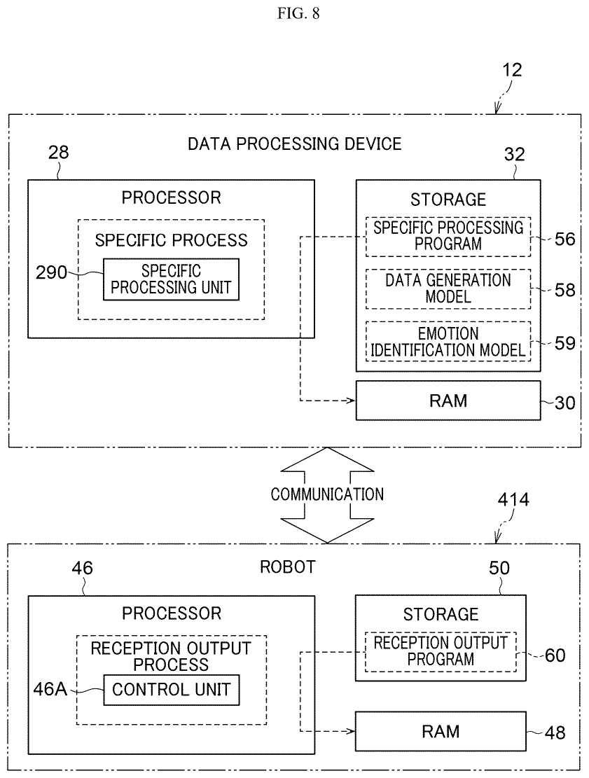

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

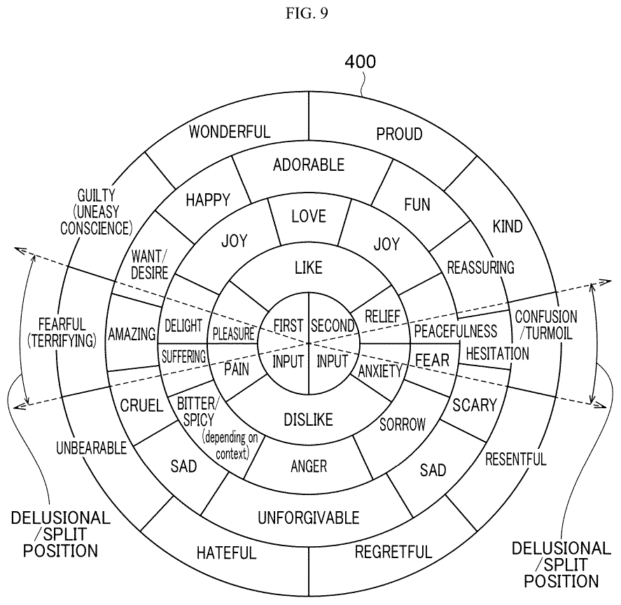

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

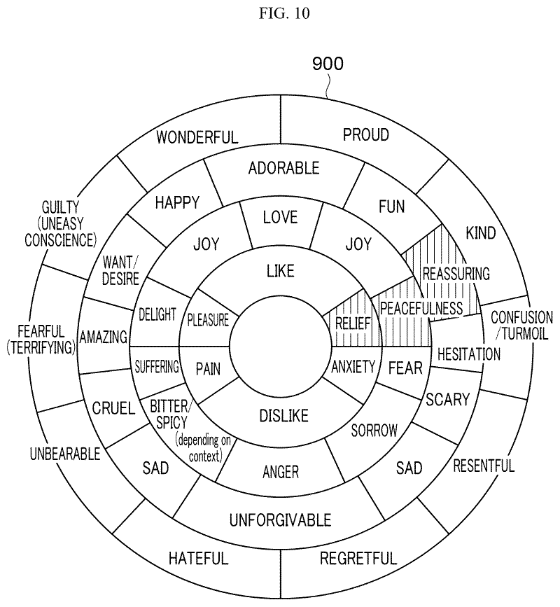

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive electronic information and extract character information and associated information included in the electronic information,
preprocess the character information to generate analysis target information by removing format information, normalizing character types, and performing word segmentation,
obtain word-level information, sentence-level information, and semantic information from the analysis target information by using natural language processing technology, and extract expression information related to danger determination,
extract identifier information from the analysis target information and the expression information, compare the identifier information with reference information stored in a storage device, and calculate reliability information,
generate a prompt sentence to be input to a generative artificial intelligence model based on the analysis target information, the expression information, and the reliability information, instruct the generative artificial intelligence model to perform danger evaluation by using the prompt sentence, and determine danger degree information of the electronic information based on response information acquired from the generative artificial intelligence model,
generate evaluation result information based on the danger degree information and the response information, and transmit the evaluation result information to a user information processing apparatus, and
generate notification information including warning information or handling instruction information for the electronic information according to the danger degree information indicated by the evaluation result information.

### (Supplementary 2)

The system according to supplementary 1,
wherein the processor is configured to
include structured instruction information in the prompt sentence to be used as input to the generative artificial intelligence model, the structured instruction information requesting an output format of classification information, danger level information, and enumeration of the identifier information, and acquire structured response information from the generative artificial intelligence model.

### (Supplementary 3)

The system according to supplementary 1,
wherein the processor is configured to
record the evaluation result information in association with the user information processing apparatus, and perform learning control to update at least one of content of the prompt sentence to the generative artificial intelligence model and conditions for determining the danger degree information, based on the evaluation result information and operation history information of a user.

### Application Example 1

### (Supplementary 1)

A system comprising a processor,
wherein the processor is configured to
acquire an electronic communication received from a user terminal and extract body information, sender information, recipient information, and associated information from the electronic communication, and structure the extracted information as internal data for analysis, and
perform preprocessing on the body information by using natural language processing, including sentence segmentation, tokenization, normalization, and detection of expressions indicating language anomalies, and extract feature information including credential input request expressions, monetary request expressions, expressions indicating urgency, identification information, and attribute information corresponding to the identification information, and
convert the body information and the feature information into a numerical feature vector and calculate a first evaluation value indicating a risk level of the electronic communication by using a statistical learning model, and
generate a prompt sentence to be input to a generative AI model on the basis of the feature information and the first evaluation value, transmit the prompt sentence to the generative AI model, and acquire from the generative AI model a second evaluation value relating to the risk level of the electronic communication and explanation information, and
determine a final danger category of the electronic communication on the basis of the first evaluation value, the second evaluation value, and the feature information, and classify the electronic communication as at least one of a safe communication, an attention-required communication, and a harmful communication in accordance with the final danger category, and
generate notification information including warning information, explanation information for dangerous portions, and recommended action information for an electronic communication classified as the harmful communication or the attention-required communication, transmit the notification information to the user terminal, move the electronic communication to a quarantine storage area different from a normal storage area, and assign access control information to the electronic communication, and store electronic communications stored in the quarantine storage area and feedback information from a user as learning data, and update the statistical learning model and generation rules of the prompt sentence so as to improve future risk evaluation accuracy.

### (Supplementary 2)

The system according to supplementary 1,
wherein the processor is configured to
execute calculation of the first evaluation value by the statistical learning model and acquisition of the second evaluation value from the generative AI model via the prompt sentence separately from each other, and integrate the first evaluation value and the second evaluation value to determine the final danger category, thereby combining rule-based feature evaluation and semantic evaluation by the generative AI model to determine a risk level of the electronic communication.

### (Supplementary 3)

The system according to supplementary 1,
wherein the processor is configured to
generate the prompt sentence by forming an instruction sentence in a predetermined format that includes at least a whole or a part of the body information, the feature information, the first evaluation value, and candidate classification results, and control the generative AI model to output structured information including a danger label, a danger score, and an explanation of danger factors.

### Example 2

### (Supplementary 1)

A system comprising a processor,
wherein the processor is configured to
acquire body information and identification information of an electronic communication, and normalize the identification information into a standardized representation by converting the identification information into a predetermined format,
compare the normalized identification information with an information set stored in an information storage unit in which reliability information is registered, and determine reliability of the identification information based on a result of the comparison,
apply a natural language processing technique to the body information of the electronic communication, segment the body information into constituent elements, extract words and expressions related to risk, and generate feature data based on an extraction result,
calculate a classification result relating to a risk of the electronic communication and a confidence value corresponding to the classification result by using a trained statistical estimation model based on the feature data and the identification information,
generate an explanatory text including the body information of the electronic communication and the identification information, construct a prompt sentence for input to a generative artificial intelligence model based on the explanatory text, and obtain an evaluation result and a reasoning relating to the risk of the electronic communication from the generative artificial intelligence model,
integrate the comparison result with the information set, the classification result from the statistical estimation model, and the evaluation result from the generative artificial intelligence model, and determine a final reliability evaluation of the electronic communication, and
generate response information including warning information relating to risk or guidance information relating to safety based on the final reliability evaluation, and form notification data outputtable to an external terminal.

### (Supplementary 2)

The system according to supplementary 1,
wherein the processor is configured to
generate input data for the statistical estimation model as a data sequence based on a plurality of types of feature data including words extracted by the natural language processing technique and the identification information, and classify the electronic communication into at least one of an unauthorized communication, an unsolicited communication, and a legitimate communication based on the data sequence.

### (Supplementary 3)

The system according to supplementary 1,
wherein the processor is configured to
change content of the prompt sentence to be input to the generative artificial intelligence model in accordance with the comparison result with the information set and the classification result from the statistical estimation model, and reflect the evaluation result and the reasoning obtained based on the changed prompt sentence in the final reliability evaluation.

### Application Example 2

### (Supplementary 1)

A system comprising a processor,
wherein the processor is configured to
generate a prompt sentence for a generative AI model, the prompt sentence being configured to cause the generative AI model to evaluate a risk level of an electronic message, based on a message body of the electronic message, identification information extracted from the message body, and analysis results of the message body,
compare the identification information extracted from the message body with a reference information set stored in a storage device, and calculate, based on a comparison result, at least one of a reliability index of the identification information and a danger index of the electronic message,
analyze the message body by using at least one of a natural language processing technique and a machine learning technique to detect grammatical errors, unnatural expressions, and high-risk phrases, and calculate, based on a detection result, a content-based danger index of the electronic message,
analyze attribute information including at least one of a source address, a transmission time, and a network parameter relating to the electronic message, and calculate, based on the attribute information, a trust index of the electronic message,
analyze emotion-related information including at least one of facial information and voice information of a user by using an emotion recognition technique, recognize an emotion of the user, and, based on the recognized emotion, adjust the danger index of the electronic message by increasing the danger index when a negative emotion is detected and decreasing the danger index when a positive emotion is detected,
integrate at least part of the reliability index, the content-based danger index, the trust index, the emotion-adjusted danger index, and an evaluation result received from the generative AI model in response to the prompt sentence, and determine, based on an integration result, a final danger level of the electronic message and explanatory information corresponding to the final danger level, and
generate warning information in accordance with the final danger level and the explanatory information, and transmit the warning information to a terminal device for notification to the user.

### (Supplementary 2)

The system according to supplementary 1,
wherein the processor is configured to generate the prompt sentence such that the prompt sentence requests the generative AI model to provide at least one of an evaluation of the danger level of the electronic message, an evaluation of safety of the identification information, and an explanation of an avoidance action to be taken by the user, based on the message body and the analysis results of the message body.

### (Supplementary 3)

The system according to supplementary 1,
wherein the processor is configured to set a priority of the electronic message based on an analysis result obtained by the emotion recognition technique, and generate, based on the priority and the final danger level, a notification sentence that prompts the user to perform a response operation to the electronic message, and transmit the notification sentence to the terminal device.

What is claimed is:

1. A system comprising:
circuitry configured to:
receive, via a communication interface coupled to a packet-switched network, network communication data from a user terminal and extract body information and network identifier data from the network communication data;
preprocess the body information using natural language processing to generate analysis target information, the preprocessing comprising format removal, character type normalization, and word segmentation, and extract, from the analysis target information, expression information related to risk determination and the network identifier data;
compare the network identifier data with reference information stored in a memory to calculate reliability information indicating an origin or trustworthiness of the network identifier data;
generate a prompt sentence for input to a generative AI model based on the analysis target information, the expression information, and the reliability information, and instruct the generative AI model to perform risk evaluation using the prompt sentence; and
determine risk degree information of the network communication data based on response information acquired from the generative AI model, generate evaluation result information based on the risk degree information and the response information, and transmit the evaluation result information to the user terminal via the communication interface.

2. The system according to claim 1, wherein the circuitry is configured to include structured instruction information in the prompt sentence requesting an output format comprising classification information, risk level information, and enumeration of the network identifier data, and acquire structured response information from the generative AI model.

3. The system according to claim 2, wherein the circuitry is configured to parse the structured response information to extract the classification information and the risk level information as discrete data fields, and store the discrete data fields in association with the network communication data in the memory.

4. The system according to claim 3, wherein the circuitry is configured to generate notification information comprising warning information or handling instruction information based on the risk degree information, and transmit the notification information to the user terminal via the communication interface.

5. The system according to claim 4, wherein the circuitry is configured to record the evaluation result information in association with the user terminal, and perform learning control to update at least one of content of the prompt sentence and conditions for determining the risk degree information based on the evaluation result information and operation history information of a user.

6. The system according to claim 1, wherein the circuitry is configured to obtain word-level information, sentence-level information, and semantic information from the analysis target information using the natural language processing, and extract the expression information by identifying linguistic patterns associated with risk indicators in the semantic information.

7. The system according to claim 6, wherein the circuitry is configured to convert the body information and the expression information into a numerical feature vector, calculate a first evaluation value indicating a risk level of the network communication data using a statistical learning model, and include the first evaluation value in the prompt sentence as supplementary context for the generative AI model.

8. The system according to claim 7, wherein the circuitry is configured to determine a final risk category of the network communication data based on the first evaluation value, a second evaluation value acquired from the generative AI model, and the expression information.

9. The system according to claim 1, wherein the circuitry is configured to acquire sensor data representing at least one of a facial expression or a voice of a user from the user terminal, apply emotion recognition processing to the sensor data to generate an emotion label, and adjust a risk level threshold for the network communication data based on the emotion label.

10. The system according to claim 9, wherein the circuitry is configured to set a notification priority for the network communication data based on the emotion label, and generate a prompt sentence for notifying the user according to the set notification priority.

11. The system according to claim 9, wherein the emotion recognition processing applies a convolutional neural network to image data representing the facial expression or applies a recurrent neural network to audio feature data representing the voice to generate the emotion label.

12. The system according to claim 1, wherein the network identifier data comprises at least one of uniform resource locator data, network address data, account identifier data, or electronic mail address data extracted from the network communication data.

13. The system according to claim 12, wherein the circuitry is configured to classify each extracted network identifier into one of a known legitimate entity, a known malicious entity, or an unknown entity based on the comparison with the reference information, and weight the risk degree information based on the classification result.

14. The system according to claim 1, wherein the circuitry is configured to apply sentence segmentation and tokenization to the body information prior to generating the analysis target information, and detect linguistic anomaly expressions in the tokenized body information as part of the expression information.

15. The system according to claim 1, wherein the circuitry is configured to record an execution log comprising the prompt sentence and the corresponding response information for each invocation of the generative AI model, and store the execution log in the memory.

16. The system according to claim 15, wherein the circuitry is configured to compare a current response information against prior response information stored in the execution log when the same network communication data is re-evaluated, and flag a discrepancy when a similarity score between the current response information and the prior response information falls below a predetermined threshold.

17. The system according to claim 1, wherein the circuitry is configured to periodically update the reference information stored in the memory by acquiring updated network identifier reputation data from an external data source via the communication interface.

18. A system comprising:
circuitry configured to:
receive network communication data from a user terminal via a communication interface, extract body information and network identifier data from the network communication data, and preprocess the body information using natural language processing to generate analysis target information comprising word-level, sentence-level, and semantic information;
compare the network identifier data with reference information stored in a memory to calculate reliability information, and generate a prompt sentence incorporating the analysis target information, expression information extracted from the analysis target information, and the reliability information;
input the prompt sentence to a generative AI model and determine risk degree information based on structured response information acquired from the generative AI model; and
transmit evaluation result information comprising the risk degree information to the user terminal via the communication interface and update at least one of the prompt sentence content and risk determination conditions based on the evaluation result information and user operation history.

19. The system according to claim 18, wherein the circuitry is configured to acquire sensor data from the user terminal representing at least one of a facial expression or a voice of a user, apply emotion recognition processing to generate an emotion label, and adjust a risk notification priority based on the emotion label.

20. A method comprising:
receiving, via a communication interface coupled to a packet-switched network, network communication data from a user terminal and extracting body information and network identifier data from the network communication data;
preprocessing the body information using natural language processing to generate analysis target information, the preprocessing comprising format removal, character type normalization, and word segmentation, and extracting, from the analysis target information, expression information related to risk determination and the network identifier data;
comparing the network identifier data with reference information stored in a memory to calculate reliability information indicating an origin or trustworthiness of the network identifier data;
generating a prompt sentence for input to a generative AI model based on the analysis target information, the expression information, and the reliability information, and instructing the generative AI model to perform risk evaluation using the prompt sentence; and
determining risk degree information of the network communication data based on response information acquired from the generative AI model, generating evaluation result information based on the risk degree information and the response information, and transmitting the evaluation result information to the user terminal via the communication interface.
